(19) United States
(12) Patent Application Publication
(10) Pub. No.: US 2006/0047598 A1
(43) Pub. Date: Mar. 2, 2006

(54) System and method for web-based procurement

(75) Inventor: Jon William Hansen, Ottawa, CA (US)

Correspondence Address: CASSAN MACLEAN, 80 ABERDEEN STREET, SUITE 401, OTTAWA, ON, K1S 5R5, CA

(73) Assignee: e-Procure Solutions Corporation, Ottawa (CA)

(21) Appl. No.: 10/930,447

(22) Filed: Aug. 31, 2004

(51) Int. Cl. G06Q 40/00

(52) U.S. Cl. 705/37

(57) ABSTRACT

The invention relates to the field of business-to-business (B2B) commerce and in particular to a real-time, computer implemented system and method for conducting a reverse auction for procuring maintenance, repair and operations components over the Internet. Integral to the present invention is a Reverse Auction Module (RAM) which is a web-based system that allows buyers or sourcing agents (SA) to electronically solicit a group of remotely situated potential suppliers to bid on a requirement. Those suppliers that respond before bid closing will have their bids evaluated by the system against multiple criteria. The system then presents the SA with the results of the evaluation. The SA or buyer is able to accept the recommendation or override the recommendation and create a proposal based on the bid information from one of the suppliers. The proposal is then given to the customer. If the customer accepts the proposal by providing a purchase order then the SA can award the opportunity to the winning supplier and create a purchase order to buy the item. Additionally, the system verifies that the price and terms offered are consistent with those that are generally available from suppliers that are not registered with the system.

### BACKGROUND OF THE INVENTION

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever

1. Field of Invention

The invention relates to the field of business-to-business (B2B) commerce and in particular to a system and method of procuring maintenance, repair and operations components over the Internet.

2. Description of the Related Prior Art

A traditional procurement model typically requires manual distribution of documents such as a Request for Information, Request for Quotation (RFQ), Request for Proposal (RFP), and/or a Specification to entities that may have an interest in bidding to provide goods and services at a competitive price. Hard copies of the formal documents are distributed to prospective bidders for a period long enough prior to the close of the bidding process so that they are able to submit their bids. When a modification is made to a request, an entire round of communications is required with paper and/or voice message exchange to inform the bidders of the changes. The administrative overhead for setting up and carrying out a “bid” is so great that only complex “big ticket” goods and services can reasonably be requisitioned using this method.

Furthermore, scoring rules are typically integrated into the procurement process. More specifically, the dimensions for selecting a winning bidder are typically not just best price, but include a variety of additional dimensions, such as the brand or quality of the merchandise proposed, the timeliness of delivery and the quality of service. For example, a bidder's technical competence, proposal quality and price might all be weighted in determining the winning bid. Thus, the bidder offering the best price at the completion of the auction may not be the eventual winner of the business contract depending on the ranking of bids generated by the scoring rules. Scoring rules have traditionally been used only in high value business-to-business or government-to-business contracting because they have been complex to administer i.e. received bids must be manually evaluated by a review team according to company or government guidelines.

The procurement of goods and/or services (as opposed to big ticket items) by an organization is typically conducted in a phone-solicitation reverse auction format by procurement specialists (or buyers). A reverse auction is a buyer-initiated auction in which a buyer invites bids from multiple sellers. In terms of procurement, there are two distinct types of purchases companies make: direct and indirect material acquisitions. Direct materials are those materials involved in the manufacturing supply chain that are directly related to the production of finished goods while indirect materials include the purchase of any commodity or service that a company buys that does not result directly in a finished good.

Indirect materials may themselves be categorized into two classes of items. The first is commonly referred to as Operating Resource Management, or ORM. Examples include common office products such as office supplies. ORM products are usually purchased over the Internet's World Wide Web, at regular intervals and on a bulk basis. While it is important to replenish supplies such as paper and pens, these commodity items are rarely in short supply and, if needed, are usually only a phone call or mouse click away.

A second class of indirect materials are referred to in the industry as Maintenance, Repair and Operations (MRO) components. MRO products are almost always mission critical spare parts that are usually required in single quantities to address an immediate service need in the field. Dependent on the specific install base at issue (in the case of IT service providers, the install base consists of computers and related high tech peripherals), MRO parts present a tremendous procurement challenge in that they tend to be older and more obscure and are not always readily available. As a result, MRO procurement within most organizations is, for the most part, inefficient and cumbersome. In fact, in relation to the traditional procurement practices used by most organizations, there is rarely a standardized policy regarding the purchase of spare parts. This leads to increased cycle times, resource inefficiency and spiraling costs. Add to the equation the tremendous fluctuation in part cost, the dependence on timely delivery and the ultimate quality of the component itself, it becomes quite apparent that improvement is needed in this specific area of procurement.

MRO parts requests are most-often based on equipment failure and virtually impossible to forecast. As a result, an organization's buying group is in perpetual react mode. Studies show that 85% of all part orders are placed between the hours of 3:00 PM and 5:30 PM, with a requirement for immediate or next day delivery at the latest. This creates a daunting challenge for MRO parts buyers. In many instances, MRO buyers are left to their own devices and resourcefulness, with only superficial guidelines in place such as comparisons with the last purchase price. This environment is a breeding ground for what is commonly referred to as “maverick” buying, which alone can typically account for a substantial increase in overall procurement costs (between 30 and 45% according to some estimates). Additionally, because buyers often ascribe to the “find or buy once, use once” philosophy, they end up leveraging only a few supplier relationships. In such instances, part requests are ultimately filled based on existing relationships with select suppliers rather than on who can offer the best overall experience in cost, delivery performance and quality. In the end, a value-based transaction is not realized as neither the end customer, nor the buyer's company gets the best value.

Typically, when a field technician submits a part request, it appears in an assigned buyer's queue. At that moment, based largely on personal experience and relationships, the buyer will contact a set group of suppliers to determine parts availability and price. If the part is not in stock, the supplier will usually indicate that they will get back to the buyer once it has been located. The buyer may make several calls to fulfill this one requirement. If this process is extrapolated over thirty, forty, or fifty parts per day within a relatively compressed time period, it is apparent that purchasing decisions are frequently based on expedience rather than price, delivery performance, or even component quality.

Even when located and ordered, the ongoing administrative requirements of the fulfillment process substantially increase procurement costs. Research indicates that 40% of the total cost of purchasing materials comes from transaction costs associated with processing and managing the order. Given the onerous demands organizations place upon their buying groups, it comes as no surprise that individual buyers will tend to jealously guard their limited number of supplier relationships, and continue to use partners even at the expense of escalating product costs, inconsistent delivery, and fluctuating product quality.

Thus, the procurement systems traditionally linked with indirect material procurement often do not take into account the need to effectively and efficiently incorporate the disparate systems of suppliers in their procurement process. As a result, MRO procurement is often disjointed and primarily dependent on human knowledge and instinct, with incomplete methods for measuring true performance. The lack of an effective solution, which simultaneously marries the objectives of the corporation with the workflow at the buyer level and the disparity of the supplier market is the significant shortfall with current procurement practices.

A recent innovation in reverse auctioning has been to use the Internet's World Wide Web facility wherein a company's procurement personnel may set up online RFQs and invite various preferred vendors to bid on the RFQS. An example of such an online procurement system is described at www.hedgehog.com where online RFQs are issued in an auction style format to fulfill a company's sourcing needs. The preferred vendors are provided with a secure online access to the RFQ's where they can compete in a real-time Reverse Auction event. Such online procurement systems help companies and government entities, of all sizes, realize savings by overcoming inefficiencies inherent in traditional paper, phone/fax based purchasing and procurement processes. However, MRO indirect material procurement has been overlooked.

Numerous organizations have already achieved significant, quantifiable benefits using online procurement (eprocurement) solutions. Corporations who have made the transition to online or web-based electronic procurement are realizing up to 90% drops in order processing costs, plus additional savings of up to 11% on the cost of the actual goods and services. One organization recently reported that their average cost per transaction went from US $120 to US $40. Based on an average reduction of US $80 per transaction, a buying group executing 1000 buys per month will save their organization US $80,000. Over twelve months, this translates into a US $960,000 savings.

The premise behind a web-based parts exchange is that it links strategic partners of the MRO supply chain through a centrally managed hub. The result is a community of collaborative enterprises that share business process and databases and are synchronized by a central coordinator. The procurement solution offered at, for example, www.hedgehog.com evaluates vendor bids solely on price as scoring rules have been traditionally complex to administer. Further, this system does not include the ability to track buyer purchases once a purchase order is generated, nor does it include a financial management mechanism or audit trail for both the supplier and buyer.

In short, the prior art online procurement systems fail to provide a fully automated solution which addresses not only the bidding process but the administrative process which follows the contract award right through to delivery. The prior art does not effectively incorporate the buyer's management purchasing guidelines into the procurement process. More specifically, the prior art does not provide a real-time, value-based procurement solution which evaluates bids on multiple criteria including price and supplier past performance record in terms of delivery performance, quality, not following through on orders (reneges) and payment terms. Furthermore, a system that verifies the veracity of the on-line bid system (i.e. that the various prices and terms offered in supplier bids are consistent with those available in the general market) and thereby eliminates overpricing is desirable.

### SUMMARY OF THE INVENTION

In order to overcome the deficiencies of the prior art, the present invention provides a real-time computer-implemented system and method for conducting a reverse auction for a maintenance, repair and operations components. Integral to the present invention is a Reverse Auction Module (RAM) which is a web-based system that allows buyers or sourcing agents (SA) to electronically solicit a group of remotely situated potential suppliers to bid on a requirement. Those suppliers that respond before bid closing will have their bids and their performance history evaluated by the system. The system then presents the SA with the results of the evaluation. The SA or buyer is able to accept the recommendation or override the recommendation (with explanation) and create a proposal based on the bid information from one of the suppliers. The proposal is then given to the customer. If the customer accepts the proposal by providing a purchase order then the SA can award the opportunity to the winning supplier and create a purchase order to buy the item.

Adhering to the principles of a value-based transaction, the system of the present invention evaluates bids based on multiple criteria including price, ability to meet delivery date, supplier's track record for quality, supplier's track record for on-time delivery, supplier's track record for not following through (reneging) and contract terms. Additionally, employing a “mirrored sourcing” technique, the system of the present invention verifies that the price and terms offered are consistent with those that are generally available from suppliers that are not registered with the system.

In accordance with one aspect of the invention there is provided A real-time computer-implemented method for conducting a reverse auction for a maintenance, repair and operation (MRO) component comprising: creating an opportunity wherein the step of creating comprises generating a bid evaluation form for a buyer, the bid evaluation form comprising a component description and a plurality of buyer selectable bid evaluation parameters including a weight for each of the parameters; receiving and storing a completed bid evaluation form from the buyer; determining a list of potential suppliers for satisfying the opportunity; broadcasting the opportunity to the list of potential suppliers; receiving a bid from each of the potential suppliers; evaluating the received bids; determining a winning bid from the evaluated bids; creating a buyer proposal; and awarding a contract to a selected one of the potential suppliers, wherein a bid price is verified through mirror sourcing, and wherein the step of mirror sourcing comprises checking a bid price offered by the potential suppliers against a market price offered by selected non-participating suppliers.

Preferably, the step of broadcasting the opportunity involves transmitting (via email) the opportunity to potential suppliers identified by the system as carrying the component in question. Upon receiving an opportunity or bid solicitation, a potential supplier clicks on the hot link provided in the email solicitation and logs into a central host server to review a list of all available opportunities for that particular supplier.

More preferably, the step of receiving a bid comprises a specified one of the potential suppliers linking to a central host server, entering a user identification and password and entering a bid.

In accordance with a second aspect of the invention, there is provided a system for conducting a real-time reverse auction for a maintenance, repair and operation (MRO) component comprising: a central host server; and a host terminal communicating with the central host server, wherein the central host server comprises a reverse auction module (RAM) and wherein the RAM comprises: a first creation sub-module for creating an opportunity wherein the step of creating comprises generating a bid evaluation form for a buyer at a remote buyer terminal, the bid evaluation form comprising a component description and a plurality of buyer selectable bid evaluation parameters including a weight for each of the parameters; a first receiving sub-module for receiving and storing a completed bid evaluation form from the buyer at said remote buyer terminal; a first determining sub-module for determining a list of potential suppliers for satisfying the opportunity; a broadcasting sub-module for broadcasting the opportunity to the list of potential suppliers at respective remote supplier terminals; a second receiving sub-module for receiving a bid from each of the potential suppliers; an evaluation sub-module for evaluating the received bids; a second determining module for determining a winning bid from the evaluated bids; a second creation sub-module for creating a buyer proposal; and an awarding sub-module for awarding a contract to a selected one of the potential suppliers, wherein a bid price is verified through a mirror sourcing module, and wherein the mirror sourcing module checks a bid price offered by the potential suppliers against a market price offered by selected non-participating suppliers.

Preferably, the central host serves communicates with the remote buyer terminal and the remote supplier terminal via a network selected from the group comprising an intranet, a wide area network and the Internet.

More preferably, the broadcast module sends an e-mail to respective remote supplier terminals.

Even more preferably a specified supplier logs into the broadcast module from an associated remote supplier terminal and reviews a list of opportunities.

The advantages of the invention are now readily apparent. The system and method herein described improves efficiency and reduces labour costs in the procurement process by eliminating the manual, paper-based processes previously used. In addition, the system and method use multiple evaluation criteria including supplier performance history to ensure that the most suitable supplier is awarded the contract. Furthermore, the system and method of the present invention define the first web-based procurement platform which provides a solution for both buyers and sellers. Finally, the system and method eliminates overpricing by constantly verify the prices offered by the registered suppliers against those available in the general market.

### BRIEF DESCRIPTION OF THE DRAWINGS

A better understanding of the invention will be obtained by considering the detailed description below, with reference to the following drawings in which:

FIG. 1A depicts a network diagram highlighting the system of the present invention;

FIG. 1B is a block diagram depicting the key software elements integral to the system of the present invention;

FIGS. 2A-2F depict a flow chart highlighting the end-to-end procurement method of the present invention;

FIG. 3A depicts a sample Bid Evaluation Parameters Table for a particular buyer;

FIG. 3B depicts a sample Bid Evaluation and Review listing in response to a bid solicitation;

FIG. 3C depicts a sample form for revising the Bid Evaluation Parameters specified in the sample table of FIG. 3A;

FIG. 3D depicts a revised Bid Evaluation and Review listing in accordance with the revised Bid Evaluation Parameters in FIG. 3C;

FIG. 4 depicts a sample completed bid evaluation form from a buyer;

FIG. 5 depicts a sample bid submission table containing entries from bidding suppliers;

FIG. 6 depicts a sample bid review table containing host mark up;

FIG. 7 depicts a sample penalty table containing penalty points assessed against participating suppliers; and

FIG. 8 depicts a sample supplier performance data table.

### DESCRIPTION OF THE PREFERRED EMBODIMENT

The present invention pertains to the purchase of indirect materials and, more specifically, to Maintenance, Repair and Operations (MRO) components using the Internet. The web-based procurement model of the present invention provides the buyer with immediate access to hundreds of possible suppliers. Such suppliers are required to register with an online auctioning host in advance. After a parts request is submitted by a buyer, within a matter of seconds, the request is electronically broadcast or transmitted to registered suppliers via the Internet. Within a pre-determined time period, those sellers (or suppliers) who wish to participate in the bid process respond electronically.

Once all bids (or proposals) have been received (i.e. after the bidding has been closed), the web-based solution assists the buyer in selecting the best possible supplier for the requested part. This is accomplished though a series of algorithms which compares a seller's (supplier's) price against those of competing bidders, as well as measuring a number of factors including delivery capability, payment terms and part quality based on past performance.

The web-based solution of the present invention then provides the buyer with a list of possible suppliers, who have been ranked (using a points system) in accordance with the purchasing guidelines established by the company's (buyer's) management. The buyer can proceed to purchase the part from the recommended supplier or, with an explanation, choose a lower-ranked supplier. In short, the ability to identify, search, select and ultimately fulfill an MRO requirement through a single event trigger defines the essence of the web-based procurement model of the present invention.

Once a supplier is selected, a buyer proposal is generated and sent to the buyer who provides a purchase order number if satisfied with the proposal. The system of the present invention then generates the necessary order documents which are sent to the selected supplier along with a query for package weight and dimensions. After the system of the present invention receives the package weight and dimensions, a query is sent to the data tables of different couriers to determine the best price relative to shipping.

The key part of the transmission or broadcast to registered suppliers in RAM is that a particular parts request is only sent out to those specific registered suppliers who carry or have access to the required part. This is achieved through the establishment of “supplier categories” which are set-up when new suppliers register with the RAM host or service provider. Without such category set-up capabilities, all suppliers would receive all parts requests as with existing auction service providers such as Computer Trading Post, Tradeloop and Bid Vantage. This typically results in a lengthy list of voluminous e-mail parts request notifications, requiring a supplier to take the time to manually sort through all requests to identify which opportunities he would like to bid on. This decreases the bid response percentage which is a serious flaw in existing bid 3 processes and systems.

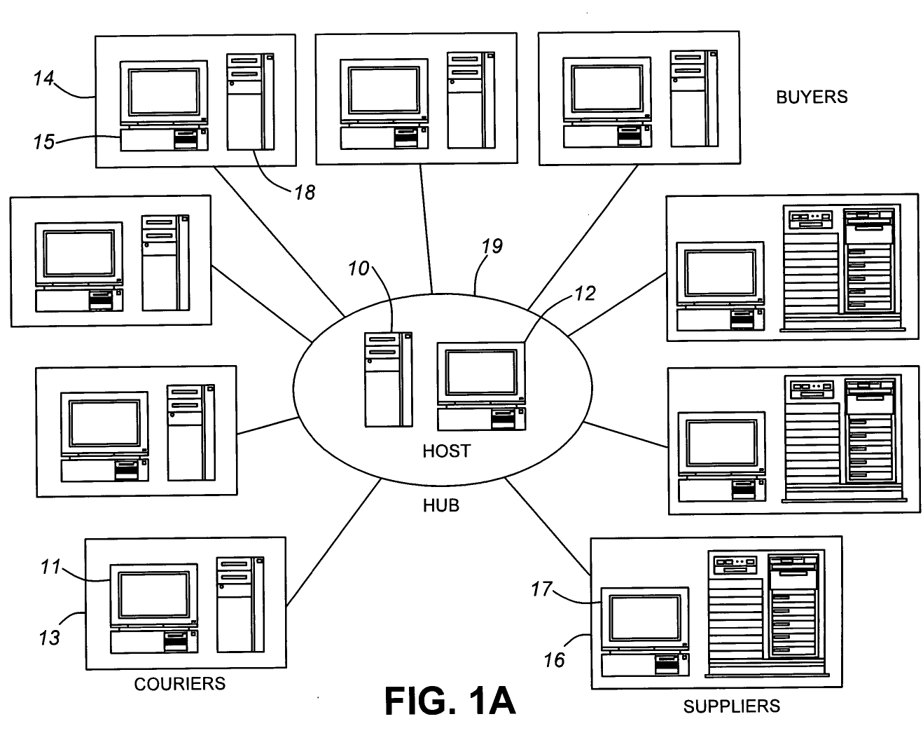

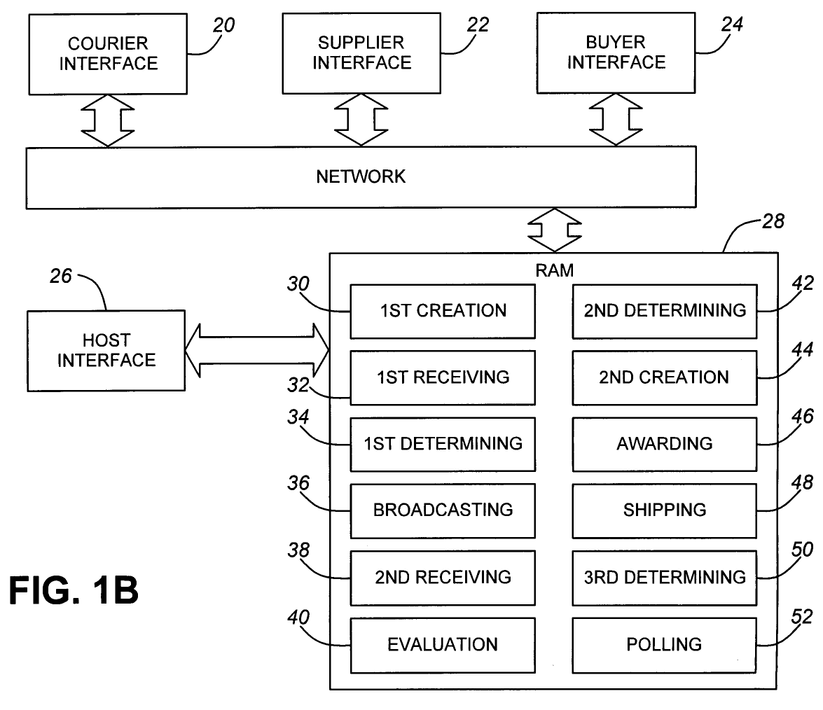

FIG. 1A is a network diagram depicting the environment in which the present invention operates. The present invention is preferably implemented as a computer program running on central host server 10 through which a sourcing agent (SA) or host interacts using host computer 12. Central host server 10 and host computer 12 comprise a private hub or metaprise 19. Buyers 14, suppliers 16 and couriers 13 access the central host server 10 using remote buyer terminal 15, remote supplier terminal 17 and remote courier terminal 11, respectively. Remote terminals 15, 17, 11 may be connected to a local area network (LAN) server 18 used in, for example, a company, or may be connected directly to a wide area network (WAN). A preferred wide area network for implementing the invention is the Internet. Buyers 14, suppliers 16 and couriers 13 log into central host server 10 to interact with a reverse auction module (RAM) as will be described in more detail below. It will be appreciated that the private hub or metaprise 19 is a coordinating layer that links together all of the entities integral to a supply chain.

FIG. 1B is a block diagram highlighting the key software elements integral to the RAM (shown generally at 28). Buyer 14, supplier 16 and courier 13 interact with central host server 10 using a buyer interface 24, supplier interface 22 and courier interface 20, respectively. The user interface may typically be a web browser such as Netscape Navigator™ or Internet Explorer™, although any commercially available web browser will suffice. Buyer 14, supplier 16 and courier 13 access the Internet using communications software such as Access Manager™ offered by Bell Sympatico which provides connectivity to an Internet Service Provider (ISP) (not shown) linked to the backbone of Internet. The RAM 28 contains a number of sub-modules which perform distinct functions in the reverse auction bid solicitation methodology of the present invention. More specifically, the RAM 28 comprises: (a) a first creation sub-module 30 for creating an “opportunity” or buyer request; (b) a first receiving sub-module 32 for receiving and storing a completed bid evaluation form from buyer 14; (c) a first determining sub-module 34 for determining a list of potential suppliers for satisfying the opportunity created in (a) above; (d) a broadcasting sub-module 36 for sending or transmitting the opportunity to the list of potential suppliers 16 determined in (c) at their respective remote supplier terminals 17; (e) a second receiving sub-module 38 for receiving bids from respective suppliers 16; (f) an evaluation sub-module 40 for reviewing and evaluating the bids received from respective suppliers 16; (g) a second determining sub-module 42 for determining a winning bid; (h) a second creation sub-module 44 for creating a buyer proposal and sending it to the respective buyer for approval; (i) an awarding sub-module 46 for receiving a purchase order from the buyer 14 and awarding a contract to a selected one of the suppliers 16 with the winning bid; 0) a shipping sub-module 48 for creating and sending order documents to the selected one of the suppliers 16 and querying the supplier for package weight and dimensions; (k) a third determining sub-module 50 for selecting the best courier (shipping) service using the package weight and dimensions from (j) above and for generating a tracking waybill number and Packing Slip; (1) a polling sub-module 52 for polling the selected courier website at timed intervals until proof of delivery (POD) information becomes available and for informing the buyer (via email) of delivery when such POD information is posted

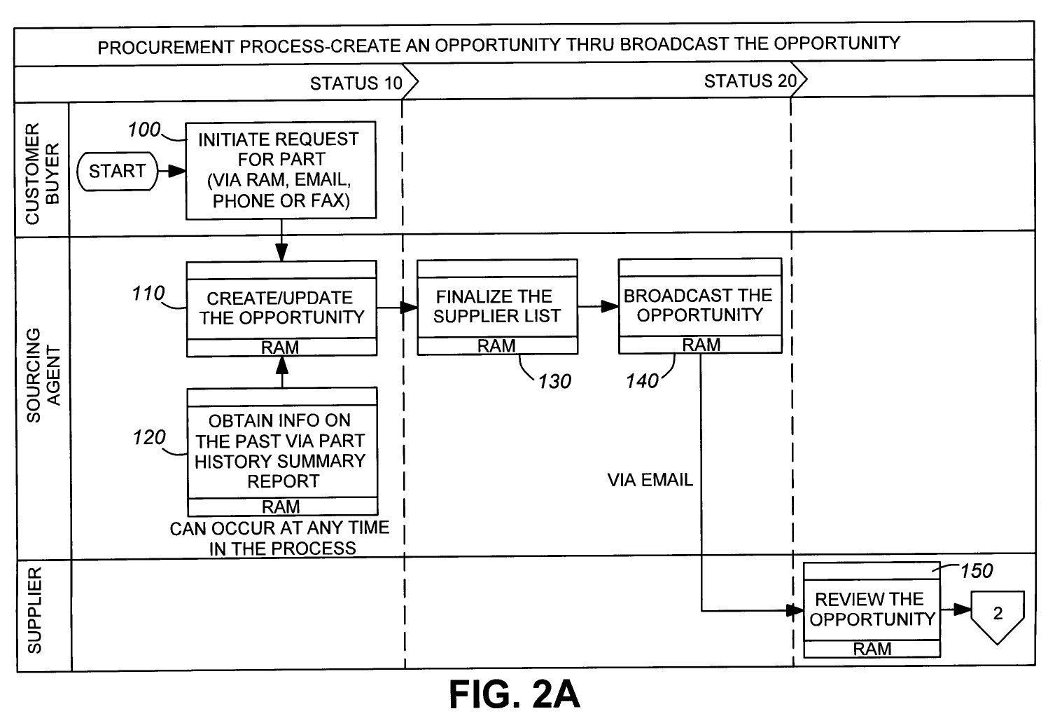

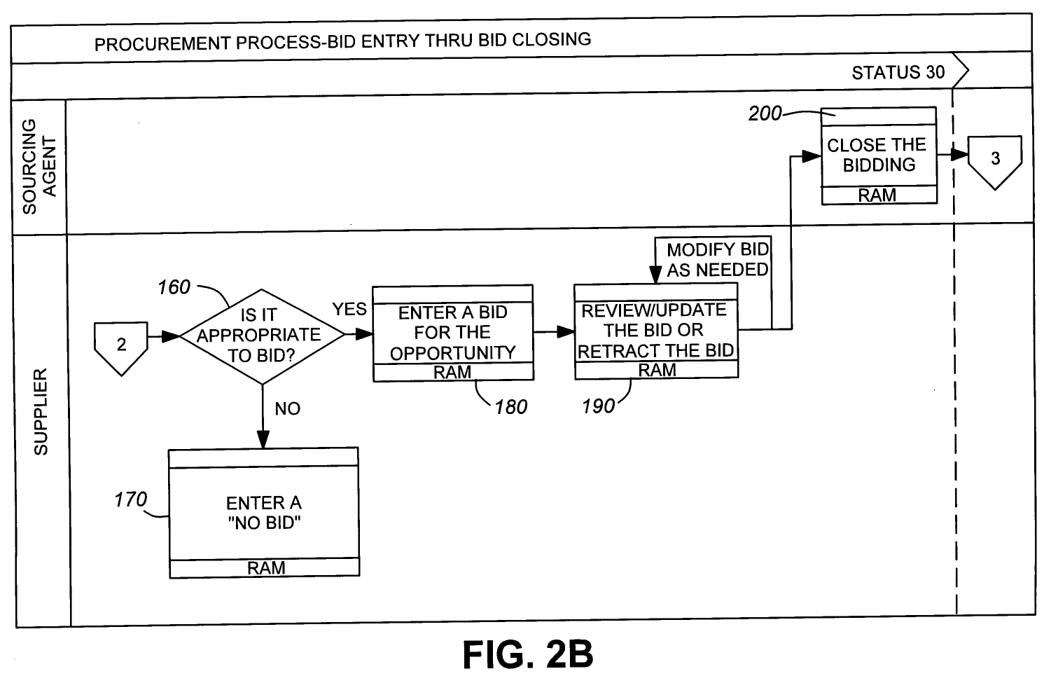

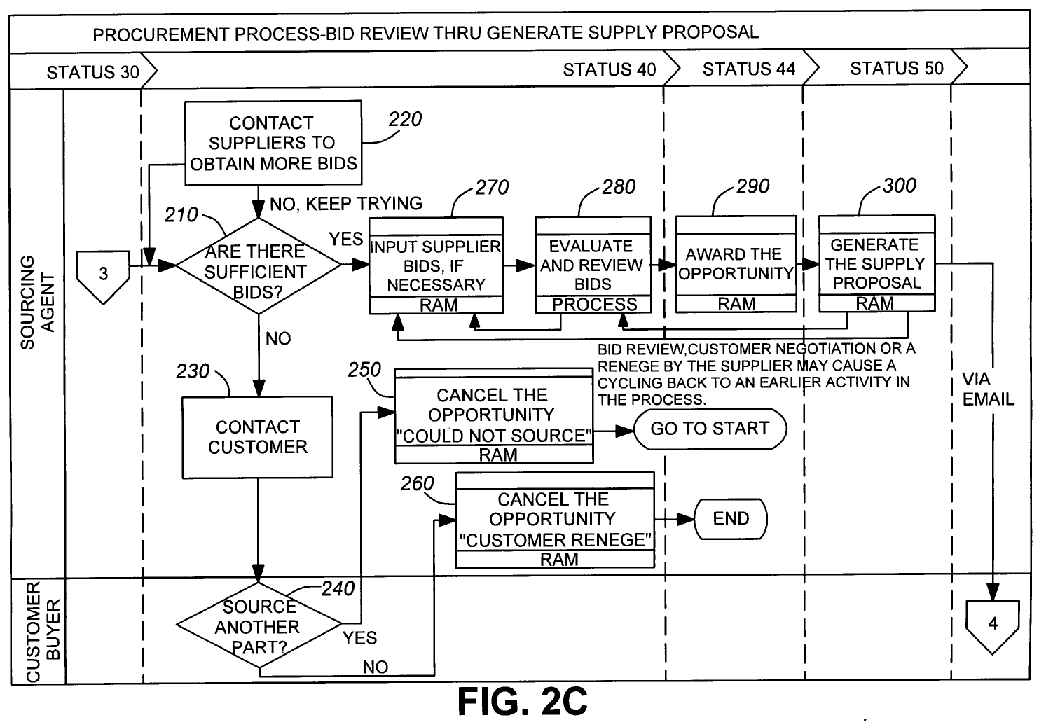

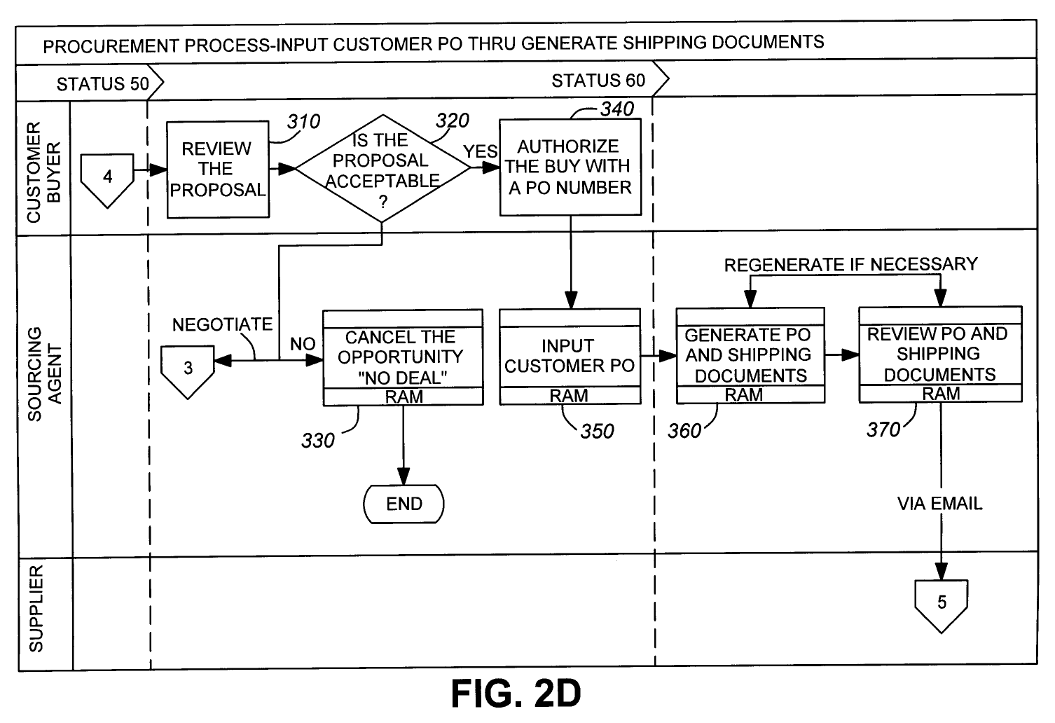

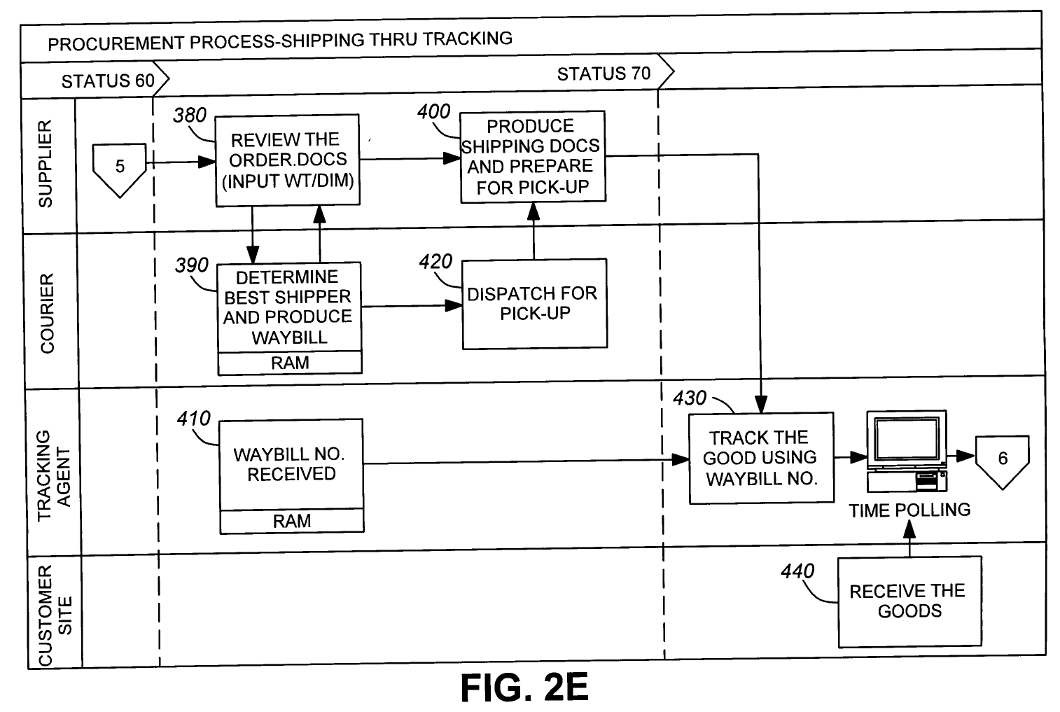

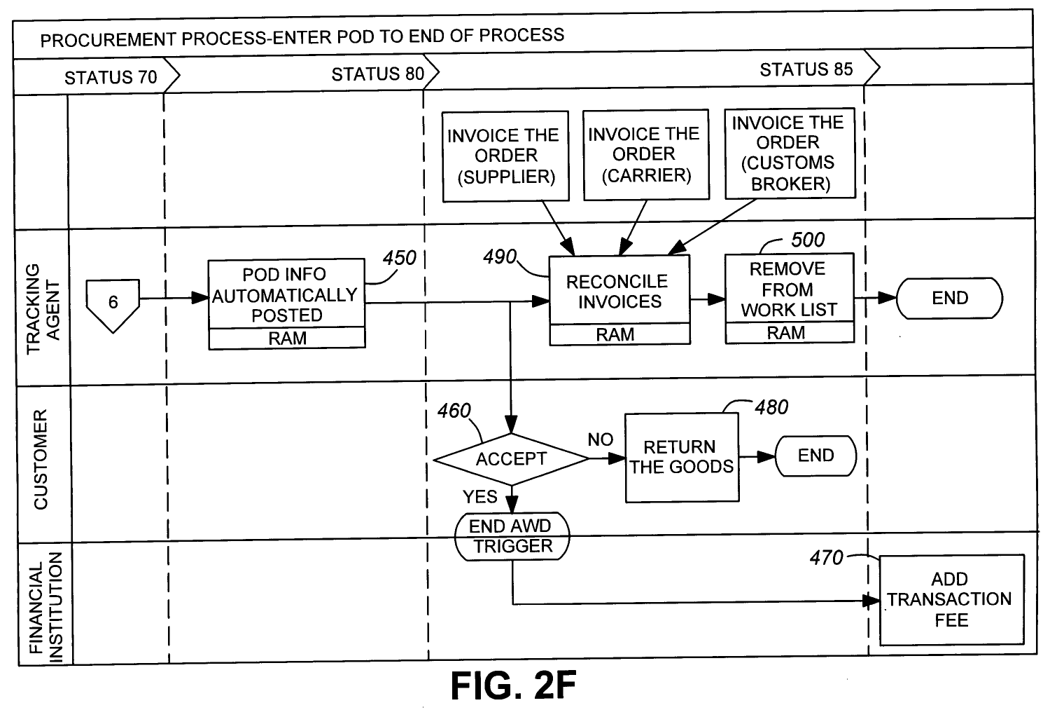

As discussed above, the Reverse Auction Module (RAM) of the present invention is composed of various functions (or sub-modules) which will now be described with reference to FIGS. 2A to 2F. At step 100 a request for a part is initiated which may include a buyer 14 e-mailing central host server 10 regarding a particular part requirement. It should be noted that the buyer 14 may also initiate a part request using more traditional methods such as by telephone or facsimile. At step 110 an “opportunity” or buyer request is created. This function is available to the Sourcing Agent (SA) or, in some embodiments, to the buyer i.e. the SA can generate the opportunity or, in some embodiments, a buyer 14 may log into the system using their assigned identification and password and generate the part request themselves. Assuming the former, the SA will associate a Bid Closing Date and Time with the opportunity when the SA opens the opportunity to bidding. The SA will also identify a minimum number of supplier responses required for the opportunity (default=1).

In relation to the creating of an opportunity at step 110, the RAM is adapted to allow the SA to alter or customize some of the bid evaluation parameters for the specific opportunity in question and to provide a reason for altering the parameters. The starting values for the five bid evaluation parameters come from a Bid Evaluation Parameters Table which has an entry for each buyer (customer). The parameters that are alterable by the SA when defining a specific opportunity are: (a) PriceMaxPenaltyPoints; (b) QualityMaxPenaltyPoints; (c) DeliveryMaxPenaltyPoints; (d) RenegMaxPenaltyPoints, and (e) TermsMaxPenaltyPoints. The values from the Bid Evaluation Parameters Table entry for the buyer (customer) are placed into corresponding fields in an Opportunity Table record as follows while allowing the SA to alter any of the parameters: (a) oppPriceMaxPenaltyPoints, (b) oppQualityMaxPenaltyPoints; (c) oppDeliveryMaxPenaltyPoints, (d) oppRenegMaxPenaltyPoints, (e) oppTermsMaxPenaltyPoints. If any parameter is altered, the reason may be provided in a “penaltyPointsOverrideReason” field. The SA will have to provide a reason so as to document why the customer's standard maximum penalty point values were altered for the particular opportunity at hand. The bid evaluation penalty point maximums become part of the opportunity record. Note that the SA may also choose to include a target cost price when defining the opportunity.

The penalty point maximums may be changed, for example, by selecting an “Alter Bid Evaluation Parameters” activity from the activity drop down list (located on a detail screen). The RAM system flow document shows the statuses for which this activity is valid.

As indicated at step 120, the SA is also able to request a Part History Summary Report for any part going back any number of months, at any time in the process. In such an instance, the system of the present invention will read through an Order Record Database via the Part Number key in date sequence (newest being first) for the Part Number in question. The default number of months worth of history to consider may be defined by a data element “Part History Evaluation Number of Months” which may be stored in a System Table. However, the SA can override that value. It should be noted that if such a report is requested by a buyer, the system will only select those records for opportunities (in the Order Record Database) that were fulfilled for that particular buyer.

The Part History Summary Report referred to above is preferably in HTML format and may contain the following fields:
Header—Part Number, Part Description, Report date;
Detail—Supplier ID, Customer ID, Date of Transaction, Alternate Part ID, Alternate Part Description, Cost Paid by Host, Price Charged by Host; and
Trailer—Number of Transactions considered, Highest Cost Paid by Host, Lowest Cost paid by Host, Average Cost Paid by Host, Most Recent Cost Paid by Host, Date of most recent buy, Date of oldest buy considered, Highest Price Charged to any Customer, Lowest Price Charged to any Customer, Average Price Charged, Most Recent Price Charged.

Referring back to FIG. 2A, at step 130, the RAM determines and finalizes the potential Supplier List for the requested part in question. Specifically, the SA (or buyer) will ask the system to prepare a list of active suppliers who provide this category of part or requirement. In this regard, upon registration with the RAM service provider, a supplier will identify the specific parts or category of parts it is capable or interested in supplying. In this important way, a part request may be sent out as a focussed solicitation to suppliers who carry or who are capable of supplying that part. In terms of the RAM system, a Supplier Table stores the status of registered suppliers and contains fields called Active and Inactive Date. When a supplier ceases to do business, the Supplier Table is updated. There also exists a Supplier-Category Table that identifies suppliers that can supply the category of the requested part in question. In finalizing the supplier list for the requested part in question (step 130), the RAM will select all entries from this table that match the category of part as identified in the Opportunity Table record. The Supplier Table will also preferably have an email address for each supplier which will be the target for electronic solicitation. In the RAM of the current invention, a Supplier Boycott Table is also maintained which contains a list of buyers who are boycotting given suppliers.

When finalizing the potential Supplier List for a given buyer's sourcing requirement (opportunity), the system will disqualify any supplier who is being boycotted by the given buyer (customer) as specified in the Supplier Boycott Table. The RAM will check the Supplier Boycott Table to see if a given supplier has been “boycotted” or “red flagged”. If “boycotted”, that supplier will not be invited to bid on the part or requirement. However, a “red flagged” supplier will still be invited to participate. A red flagged supplier is not specific to a particular buyer but is red flagged globally for all opportunities. Such red flagged suppliers will still continue to receive bid solicitations and it is up to the SA or buyer to then determine whether or not to engage in transactions with such suppliers.

For each supplier determined to be eligible to bid on the sourcing requirement, the RAM will add entries to a Supplier Open Opportunity Table stored on the central host server 10. The Supplier Open Opportunity Table stores or holds the suppliers to which the current opportunity (sourcing requirement) is broadcast. However, when the Evaluation sub-module 40 in FIG. 2B (for evaluating bids from the prospective suppliers) is run, entries in the Supplier Open Opportunity Table for the opportunity in question will be added to the Supplier Opportunity History Table and will be subsequently removed from the Supplier Open Opportunity Table.

In the present embodiment, the SA is able to review the generated potential suppliers list and, preferably, is able to manually add a supplier to the list. However, the SA is not able to remove system-nominated suppliers from the list. Furthermore, the system will warn the SA if it tries to add a supplier to the list who has been specified (in the Supplier Boycott Table) as being boycotted by this particular buyer (customer). It will be appreciated that the Supplier List is valuable information and will remain as part of the history of the particular opportunity at hand. In the full service “outsourcing model” of the present invention, buyers (or customers), are not privy to the list of suppliers identified as being eligible to bid on the sourcing requirement but are only able to find out how many suppliers are on the list. However, in a self service model where a buyer may pay a licensing fee to use the RAM system himself, the buyer in effect becomes the Sourcing Agent and is, therefore, able to access the same information available to the Sourcing Agent in the full service model.

At step 140, when the SA (or buyer) is satisfied with the Supplier List, the SA (or buyer) will instruct the system (RAM) to broadcast the opportunity (sourcing requirement) to the list of eligible suppliers via email. At this time, the SA is presented with a screen allowing the SA to identify a future date and time when the opportunity should be closed from bidding. Preferably, the SA is also able to specify the minimum number of bids desired. Furthermore, the SA is also able to identify to the system a ‘target’ cost price.

The broadcast function (at step 140) updates the opportunity status from 10 to 20 as shown in the status bar at the top of FIG. 2A . Specifically, the system (i.e. RAM software residing on central host server 10) will generate an email for each suitable supplier in the potential suppliers list. The email will describe the opportunity and the bid closing date and time and will invite the supplier to bid on the sourcing requirement. The email will preferably include a URL which will enable the supplier to access a bid entry website and will also identify other specific open opportunities that the supplier may bid on. The most current opportunity (i.e. the opportunity for which the supplier received the email solicitation) will be highlighted. The email will be from the SA's email address. The email will also contain SA contact information (i.e. each buyer will have a reverse auction host SA associate). Once the opportunity reaches status 20 many of the opportunity data values will be frozen—these include customer, part, quantity and category.

It will be appreciated that some suppliers may choose to not receive email solicitations but will instead prefer to ‘logon’ to the system at their choosing in search of opportunities. Such a preference may be indicated by a field in the Supplier Table called “Send Email Notifications”.

At step 150, a supplier who has been the target of an email solicitation to bid on the sourcing requirement reviews the opportunity in question. A supplier who wants to bid on the opportunity will click on the URL supplied as part of the email that solicited the particular supplier's participation. The URL connects the supplier with the bid entry functions on the RAM host's website. Specifically, the supplier may be presented with a logon screen. In response, the supplier keys in his ‘user ID’ and ‘password’ and, if accepted, the system will branch to the bid entry process. The RAM system then retrieves a list of all the opportunities that are still open (i.e. whose closing date and time has not yet been reached) and that the supplier has been invited to bid on. The screen on the supplier terminal will preferably identify those opportunities where the supplier's bid exists and those opportunities that have not yet been bid on. At step 150, the supplier then reviews the new opportunity.

It should be noted that the URL included in the email to the supplier will contain an opportunity identifier and the most current opportunity (i.e. the opportunity resulting in the email solicitation) is thereby highlighted on the list of opportunities presented to the supplier after successful logon. Furthermore, if a specific opportunity is closed, the screen will so indicate and the supplier will not be allowed to select the closed opportunity for bid entry. However, the supplier will be able to select any of the listed (and still open) opportunities to bid on. In other words, the bid entry screen will only be accessible if the opportunity has not closed (or been cancelled).

The Bid Entry Screen presented to the supplier is preferably comprised of the following data fields:

| | |
|---|---|
| Vendor Identifier | supplier ID from URL info |
| Vendor Name | supplier company name from |
| | Supplier Table |
| Vendor | supplier address |
| Address | from Supplier Table |
| Opportunity ID | selected from |
| | list on previous screen |
| Closing date | from Opportunity Record |
| Closing Time | from Opportunity Record |
| | (includes time zone) |
| Date Required | from the Opportunity Record |
| Time Required | from the Opportunity Record |
| Date Proposed | supplier may suggest a later |
| | date |
| Time Proposed | supplier may suggest a later |
| | time |
| Part Number | from Opportunity Record |
| Part | from Opportunity Record |
| Description | |
| Ship To | from Opportunity Record |
| Address | |
| Shipping | (for future use) |
| Weight | |
| No substitute | from Opportunity |
| | Record-disallows |
| | Alternate Part |
| No refurbished | from the Opportunity Record |
| parts allowed | |
| Bid Type Flag | supplier may choose |
| | to tell us that he |
| | is not bidding = Same, |
| | Alternate or No bid |
| No Bid Reason | supplier may want to |
| | give us a reason |
| Exact Part | Y/N |
| Refurbished | If allowed supplier can |
| | indicate |
| Alternate | supplier may enter an |
| Part Id | alternative |
| Alternate | supplier may enter |
| Part Desc | an alternative |
| Price Bid | supplier enters the |
| | unit price |
| Currency | supplier's bid |
| | currency from Supplier Table |
| Extended | system calculates = |
| Price | (unit price * quantity) |
| Shipping Cost | supplier enters an amount to be |
| | charged |
| Shipping | from Supplier Table-says who |
| Note | will arrange shipping |
| Contact Name | person entering bid info |
| | will identify themselves |
| Bid Comment | supplier will be able |
| | to provide a comment |
| Qualified | Y/N default is Y-this |
| flag | field is hidden |

As indicated at step 160, if the supplier decides not to bid (for whatever reason) on the current opportunity, then at step 170 they enter a “no bid” by entering the appropriate value in the Bid Type Flag field. If they decide to bid, however, then at step 180 the supplier enters a bid for the opportunity. In entering a bid, the supplier need only to provide input for the data fields that are in bold text above. Inputs for the non-bolded fields are derived from the sources as indicated (i.e. the non-bolded fields are protected from data entry).

As indicated by the cycling or loop at step 190, it will be appreciated that any potential supplier may revisit the bid entry screen and review and modify a bid any number of times up until the specific opportunity closes. In any case, after a supplier enters a bid, the Opportunity Supplier List is updated to indicate that a bid was received from the particular supplier. The system can optionally generate a report on a supplier's participation in the opportunities presented.

In some situations, the supplier may want to bid but may be unable to meet the buyer-specified date and time requirements for delivery. As indicated by the ‘Date Proposed’ and ‘Time Proposed’ fields on the Bid Entry Screen, the RAM system allows a bidding supplier to provide an alternate time frame but it should be noted that this may disqualify the supplier from participating in the bidding if the date and time requirements for delivery are not flexible (in certain instances, the SA may be able to negotiate a different deadline with the buyer).

As mentioned, at any given time before the auction closes, a supplier may revisit its bid and lower the bid price or cancel the bid altogether. If the supplier wants to increase its bid price, the supplier must cancel its existing bid and resubmit a new bid. The bid screen available to the sourcing agent will show the current low bid. To prevent last-minute price hikes (e.g. from suppliers who initially low ball in an effort to discourage competing suppliers from bidding), the RAM system is adapted to not allow a supplier to resubmit a new bid until a certain amount of time has passed from when the previous bid was cancelled. Furthermore, cancelled bids are not deleted from the system—they are only flagged as cancelled and are date-stamped in accordance with when the cancellation occurred. The amount of time that must lapse between cancellation of a bid and resubmission of a new bid may be incorporated as a parameter stored in the System Table. In any event, a supplier who tries to increase their bid too close to bid closing may be shut out from bidding. However, a bid may be cancelled right up to auction closing time. The RAM system is adapted to notify the SA responsible for the opportunity of any last minute bid cancellations. The SA may also exercise some discretion and, consequently, should be wary of last minute price hikes. If the opportunity turns out to be difficult to source, the SA may also choose to contact the buyer.

At step 200, bidding for the opportunity (sourcing requirement) in question is closed in accordance with the auction closing date and time set out upon creation of the opportunity. After bidding is closed at step 200, the status changes to 30 as indicated by the status bar. The system then determines if sufficient bids (determined by minimum number of bids value entered by the SA before the opportunity is broadcast) have been received at step 210. If insufficient bids have been received, the SA contacts suppliers at step 220 to obtain more bids. Ultimately, if enough bids are not solicited, then at step 230 the buyer (customer) is contacted and asked, as indicated at step 240, if a replacement part is to be procured. If not, at step 260, the opportunity is cancelled and recorded as a ‘could not source’. If a replacement part if to be procured then, as indicated at step 250, the opportunity is cancelled and replaced with a new one. In such a case, the process loops back to step 110 with the creation of a new opportunity and so on and so forth. If sufficient bids are received, the SA may proceed as indicated at step 270 to optionally input additional bids if, for example, a supplier does not have access to the system.

Simultaneous to RAM's automated bid solicitation methodology, SA's preferably solicit, through the utilization of more traditional methods, additional suppliers in what is termed a “mirrored sourcing” procedure. This procedure is designed to include non-registered suppliers in the bidding process, as well as encourage registered suppliers who, for whatever reason, have not yet submitted a bid to do so. Through this mirrored sourcing procedure, the SA can monitor the veracity of the bids received as compared to the general ‘open’ market. Advantageously, the mirrored sourcing procedure also serves as a vehicle to drive new supplier registration. The mirrored sourcing procedure also has a business intelligence aspect which will be discussed later. Essentially, the mirrored sourcing procedure is an integral part of the cross verification process that is necessary to ensure that the RAM does not operate in a vacuum.

After the closing of the auction for a particular sourcing requirement, circumstance may dictate that no supplier is able to meet the delivery date and time requirements of the buyer (customer). In such instances, the SA may negotiate a different delivery date and time requirement with the buyer and rebroadcast the opportunity. The RAM is adapted to allow the SA to change the delivery time requirement.

Furthermore, the SA may enter or change a bid for a given supplier even after bid closing. For example, if the buyer is critical of the price received from the bidding process, the SA can revert to negotiating with a supplier via the phone or find another source. This will necessitate a post close bid entry. Alternatively, an urgent sourcing requirement may arise where there is no time for email solicitation. In this situation, the opportunity status will go from status 10 to status 50 as quickly as possible i.e. the SA will key in the bid, propose a winner and a price and gets a purchase order from the buyer (customer) within minutes.

At step 280, the bids are evaluated and reviewed using Buyer and Seller Algortihms. It will be appreciated that the RAM of the present invention is unique in that it combines two distinct multi-attribute algorithms, thus eliminating the hostile nature normally associated with current (reverse) auction environments. The system of the present invention also neutralizes the subjective nature of buying decisions through the objective, real-time measurement of key buyer-defined purchasing criteria.

With regard to evaluation and review of the bids at step 280, the SA selects a “Bid Evaluation” function for the given opportunity causing the system to check to ensure that the closing time for the auction has been reached. The product of this phase is a Bid Evaluation Report the creation of which involves a preparation step and an analysis step. The preparation step ensures that the opportunity status reflects a status of 30. If the status is 30, the process: (a) checks if a given supplier submitted a non-cancelled bid and sets the field “Bid Submitted” accordingly in the given Supplier Open Opportunity Table (Note that the moving of the Supplier Open Opportunity Table entries into the Supplier Opportunity History Table will not happen until Proof of Delivery (POD) information is entered); and (b) updates the status to 40 on the Opportunity Record and on the Work List Table.

During the preparation step, the system will calculate the recommended mark-up (i.e. transaction fee) for each bid record. To determine the recommended transaction fee for each bid record, the system starts with the supplier's cost expressed in the currency of the customer (buyer), referred to as Supplier's Local Cost (SLC), and the buyer's mark up scale value. It will be appreciated that mark up scale values for individual buyers may be stored as entries in a Mark Up Scale Table. The mark up in cost is exclusive of brokerage, shipping and taxes. Then, to establish a Suggested Price, brokerage and shipping are added to the marked up price expressed in the customer (buyer) currency as well as any taxes that are not passed along (so suggested price does not include GST if the customer is Canadian since a line item is added on the host's invoice called GST; thus, GST gets passed thru to the customer). The transaction fee is calculated in order to derive the Suggested Price. The Suggested Price is shown on the Bid Review document and is placed in the corresponding Bid Record.

Evaluation of bids with the RAM of the present invention is conducted using Buyer and Seller components in a penalty points scoring algorithm. In terms of the Buyer component, various Bid Evaluation Parameters are established by each buyer on either an individual opportunity (transaction) basis or on a contract specific basis. Such Bid Evaluation Parameters may be stored in a Bid Evaluation Parameters Table which has a respective entry for each buyer. These parameters are alterable by the SA when defining the opportunity. When creating the opportunity, the values from the Bid Evaluation Parameters Table for the particular buyer in question are placed into corresponding fields in an Opportunity Table while at the same time allowing the SA to alter any of the parameters if need be in accordance with, perhaps, opportunity-specific buyer instructions. It will be appreciated that the Bid Evaluation Parameters define the weighted importance of each key purchasing criteria (price, quality, delivery capability, instances of renege and terms offered) for a particular buyer by establishing a maximum number of penalty points to be awarded for a supplier not meeting such criteria. A floor to ceiling range is defined which determines the point at which a penalty is levied and what percentage of the maximum number of penalty points will be applied for each category of purchasing criteria.

The Seller component of the algorithm is basically a scorecard based on both historical and current factors/values. Historical values relate to measurements of past performance in critical procurement criteria or categories such as delivery and quality. Current values relate to price. Other factors which impact the bidding supplier's overall score include terms offered as well as reneges on past transactions.

The Seller's scorecard in each of the above categories are simultaneously matched to the Buyer component of the penalty points scoring algorithm (i.e. the five Bid Evaluation Parameters). The Bid Evaluation Parameters are comprised of the same criteria as the Seller's scorecard but ‘weighted’ in accordance with the buyer-specified tolerance range for each of said categories. Thus, for each supplier bid, penalty points are calculated for each category according to the weighted importance of each key purchasing criteria as defined by the buyer within the Bid Evaluation Parameters Table. The penalty points are then summed to arrive at a ‘TotalPenaltyPoints’ value for each supplier bid.

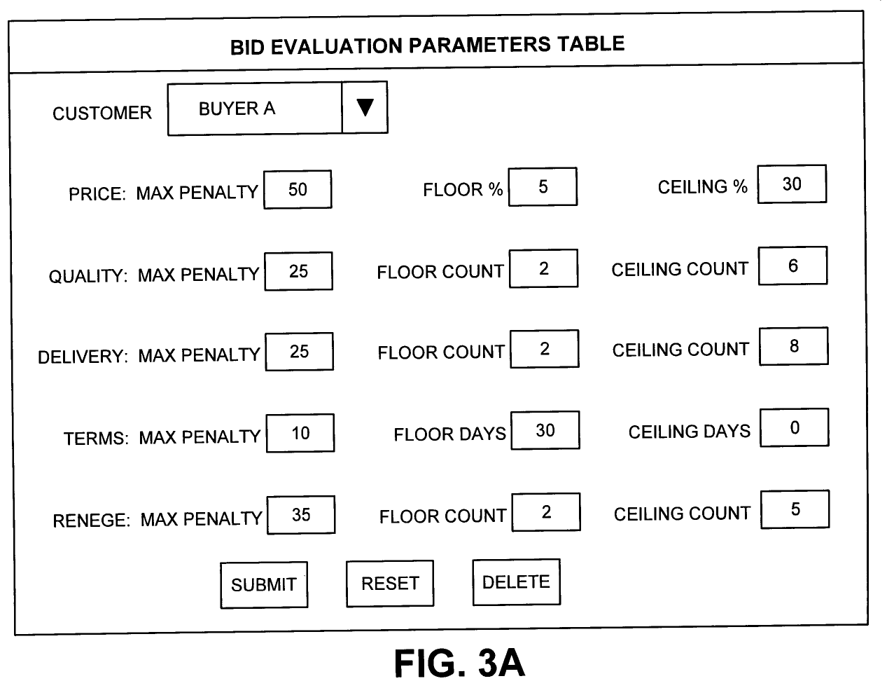

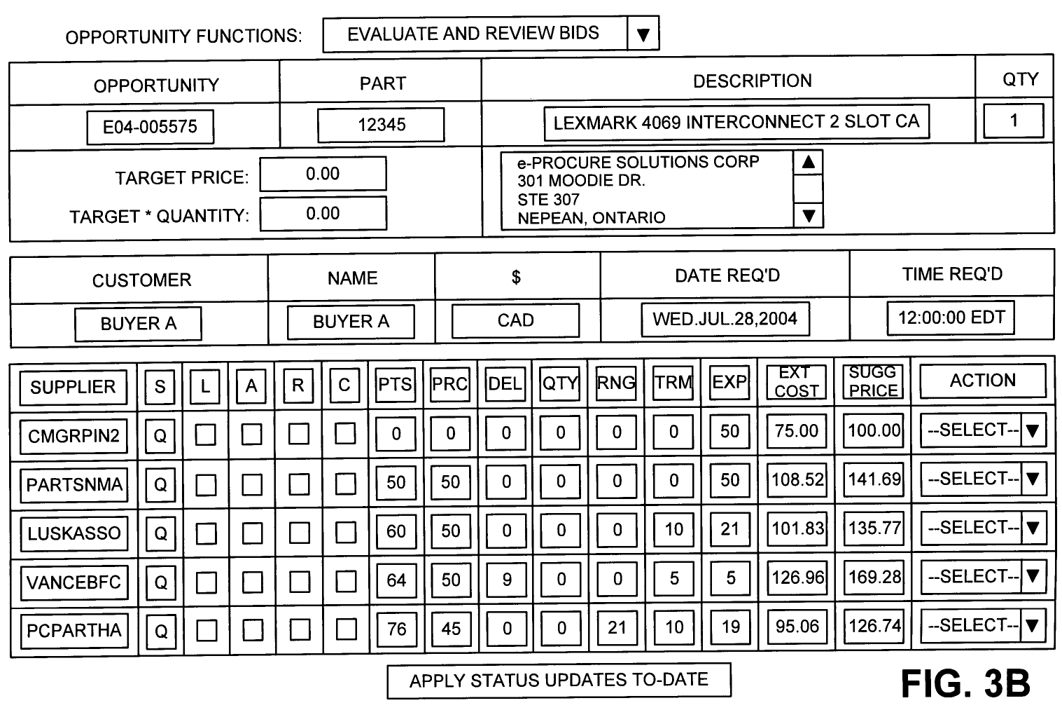

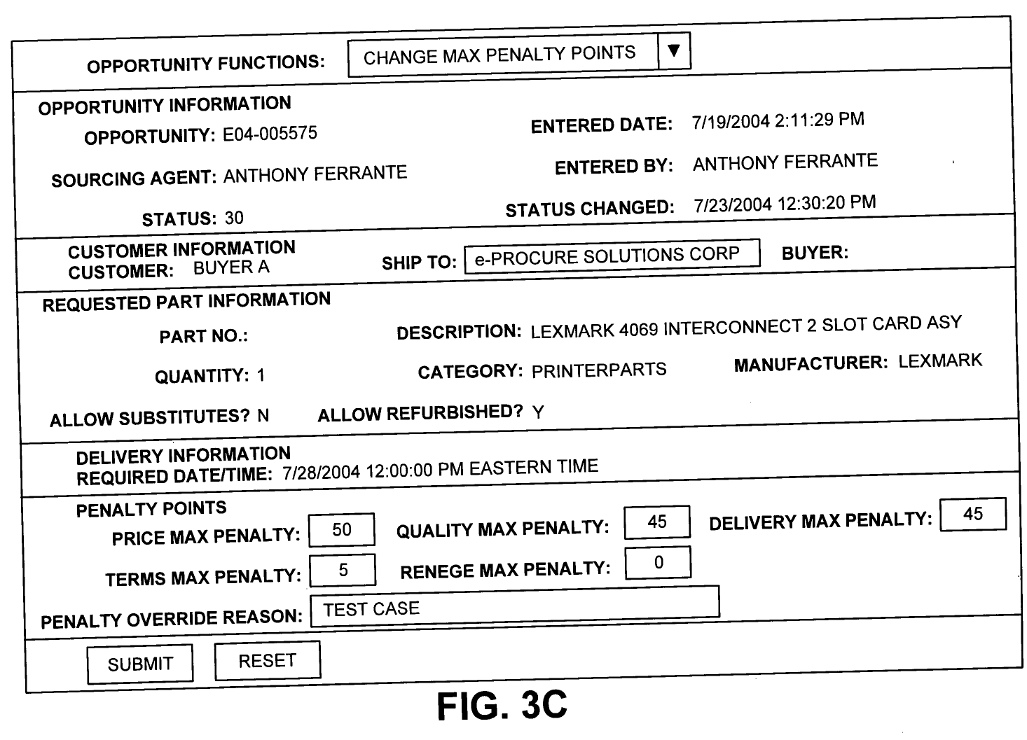

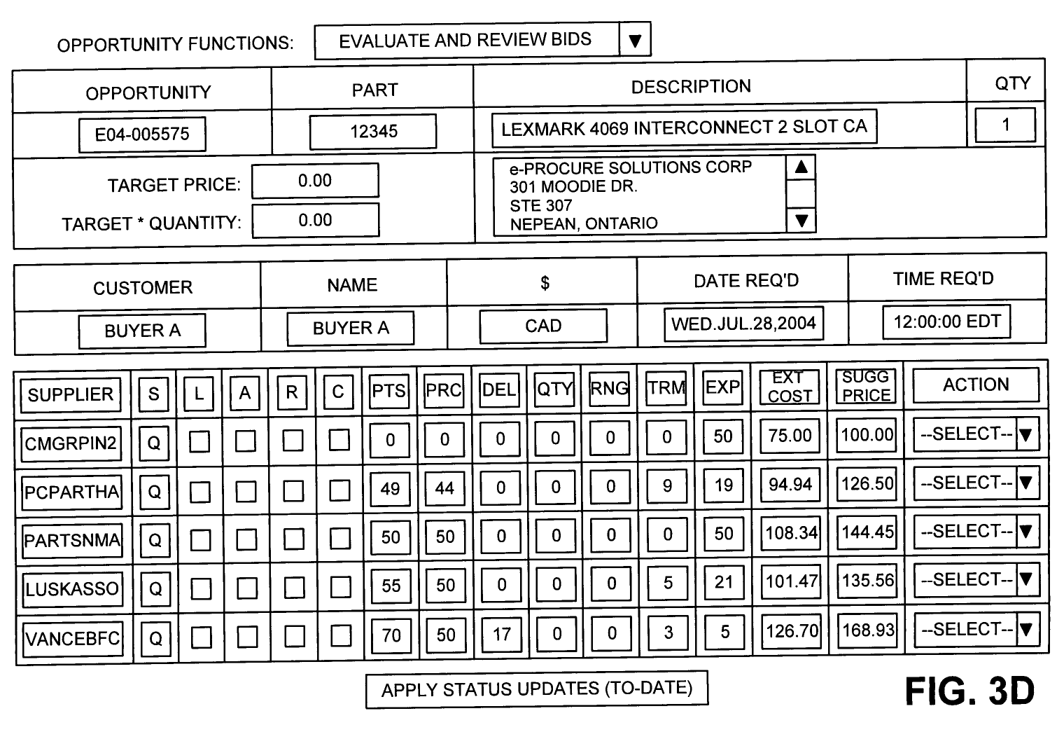

An example of how the penalty points scoring system within the RAM works is illustrated with reference to FIGS. 3A—3D. FIG. 3A shows a typical example of the entries in a Bid Evaluation Parameters Table for a particular buyer, for example Buyer A. Maximum penalty points (i.e. weightings) as well as floor to ceiling ranges for each of the five key procurement categories are defined as shown. As can be seen, the Bid Evaluation Parameters that have been established in this particular example are heavily weighted for price (current value) and reneges (historical value). It is important to note that while one or two categories may have a greater weighted value as in this example, the other categories are not disregarded. It simply means that the impact of the lesser weighted categories relative to the calculation of penalty points will have less of a bearing on the selection of the winning bidder or supplier.

Referring now to FIG. 3B, Buyer A posts a request in RAM for part 12345. As shown in FIG. 3B, five suppliers respond to the request. In FIG. 3B, the following column fields are defined as follows:
Pts total penalty points applied to supplier's bid
Prc penalty points related to pricing calculated in accordance with buyer's Price Bid Evaluation Parameter (this is a current value)
Del penalty points related to delivery performance in accordance with buyer's Delivery Bid Evaluation Parameter (this is an historic value)
Qlty penalty points related to quality performance in accordance with buyer's Quality Bid Evaluation Parameter (this is an historic value)
Rng penalty points related to renege incidence rate in accordance with buyer's Renege Bid Evaluation Parameter
Trm penalty points related to terms offered in accordance with buyer's Terms Bid Evaluation Parameter

Based on past performance combined with current pricing, and matched against the established Bid Evaluation Parameters defined in FIG. 3A for Buyer A, the suppliers are ranked accordingly in ascending order of total penalty points (see Pts column). In this particular instance, the supplier with the second lowest price (i.e. PCPARTHA) is actually ranked last behind a supplier whose price was approximately 33% higher. This is due to the fact that Buyer A's Bid Evaluation Parameters had a low tolerance to reneges. Since supplier PCPARTHA had reneged more than twice but less than five times in the previous 50 transactions, it received 21 or a possible 35 penalty points under the Renege category which was enough to significantly drop it in the overall rankings.

If the weightings or Bid Evaluation Parameters are altered for the above example, the ranking of suppliers will change accordingly. For example, in the screen shot of FIG. 3C, the Bid Evaluation Parameters are changed so as to be heavily weighted for price (current value), quality (historic value) and delivery (historic value). This is illustrated in the ‘Penalty Points’ section where

| | | |
|---|---|---|
| Price Max | Quality Max | Delivery Max |
| Penalty: 50 | Penalty: 45 | Penalty: 45 |
| Terms Max | Renege Max | |
| Penalty: 5 | Penalty: 0. | |

In this case, the buyer does not consider part reneges to be important. It is assumed that the same five suppliers respond to the revised request with the exact same pricing as before. However, as shown in the screenshot of FIG. 3D, when the same past performance scorecards for each supplier combined with the same pricing as before are now matched against the revised Bid Evaluation Parameters, the supplier who was previously ranked last (i.e. PCPARTHA) has now moved up to second in the rankings. Therefore, the simultaneous linking of two distinct components (buyer and seller) in the RAM scoring algorithm effectively and objectively selects the best supplier (based not just on pricing but on the five key procurement criteria) to fulfil a sourcing requirement on a real-time basis.

It should be noted that, as part of the bid review process, the SA may first review the Part History Summary. The SA may next request a bid review for the opportunity in question. As mentioned, the RAM will present the bids in ascending sequence of totalPenaltyPoints; that is to say that typically the supplier with the lowest total number of penalty points wins and will be at the top of the list. It will be appreciated that the SA can disqualify a bid for various reasons and have the system redo the pricePenaltyPoint calculation encompassing the remaining suppliers. The SA may then pick the supplier (having the lowest number of total penalty points) whose bid will become the basis of a proposal to the buyer. However, if the SA selects a supplier who is not the one with the least amount of total penalty points, the SA must provide a reason for choosing that specific supplier. The selected supplier's Bid Record is subsequently updated to indicate a winning bid, reason, and date and time stamp.

As mentioned, during the bid evaluation stage 280, the SA can choose to disqualify a supplier during bid review. Such an action will necessitate a reason to be given by the SA. A Bid Review Report will preferably show all of the components of the cost including system generated mark-up (i.e. transaction fee) and subsequent suggested price. The SA is able to tell the RAM system what price to include in the proposal to the buyer (customer). This price will be in the buyer's currency and will include a shipping estimate, duty, brokerage fees and any supplier included taxes. The price will not include any taxes that will be charged by the reverse auction host. The system generated price as well as the SA proposed price then become part of the Opportunity Record.

It should be noted that the bids will be evaluated in the currency in which the reverse auction host (service provider) bills the customer (i.e. buyer's currency). The customer currency is preferably stored in a Customer Table stored on the central host server 10. The RAM retrieves the appropriate exchange rate from an Exchange Rate Table (also stored on the central host server 10) and converts from the supplier's currency to the buyer's currency. For each bid record, the RAM calculates a Final Bid Amount, which is referred to as “Supplier's Price”.

With regard to brokerage fees, a ‘Ship To Address’ field is preferably included in the Opportunity Record, the value of which is compared to the supplier's country to determine if a brokerage fee will need to be applied. The fee may be zero or will correspond to an amount stored in the Customer Table. There will be a shipping charge whether the RAM host arranges for shipping or whether the supplier does. If the supplier chooses to arrange for shipping, the supplier will indicate a shipping fee on the Bid Entry Record and this fee will be converted to the buyer's currency using the exchange rate stored in the Exchange Rate Table. It should be noted that should a supplier choose to utilize their own shipping account, they will be required to enter the cost of shipping at the time their bid is submitted thereby incorporating it into the supplier side algorithm relating to price. In a preferred embodiment, the RAM host will arrange for shipping and the applicable shipping rate is retrieved from the Customer Table and will be in the correct currency.

It will be appreciated that there will be a different Bid Review Report for buyers who are themselves empowered to request a Bid Review Report. Such would be the case in a self-service model of the RAM wherein a buyer may register and pay to use the RAM service without the need for a RAM host sourcing agent (SA). With access to the same information as the SA under the full service model, they buyer under the self-service model may then determine which of the bids will be awarded under the contract. The buyer may then determine which of the bids will be awarded the contract.

Referring back to FIG. 2C, subsequent to reviewing the bids, the SA awards the opportunity to the winning bidder (i.e. the supplier with the least number of penalty points) at step 290. As shown in the status bar, the opportunity status changes to status 44. At step 300, the SA requests that the RAM generate a supply ‘proposal’ for the opportunity using the information from the winning bid. In preparing the supply proposal for the buyer, the SA provides a price that the buyer is requested to pay. The price quoted the buyer preferably includes shipping, brokerage, exchange, and the transaction fee. However, the price quoted does not include taxes charged based on destination. Such taxes are preferably added onto the final invoice. If the SA defines a price to be charged that is less than the price recommended by the RAM system, the SA will be required to provide a reason.

In a preferred embodiment, the supply proposal is stored as a PDF file and is preferably stored in a Document Table on the central host server 10. The SA may email the proposal to the Buyer by selecting an “Email Proposal to Buyer” activity from the activity drop down list. The RAM then presents the SA with a confirmation screen showing the opportunity ID, the buyer name and the buyer email address that will be used. The SA can choose to proceed with the mailing of the supply proposal or cancel.

Referring to FIG. 2D, the buyer reviews the proposal at step 310. As indicated at step 320, the buyer then decides if the proposal is acceptable. If the buyer decides to not accept the proposal at step 320 (for whatever reason be it issues with delivery date, price etc.), then the opportunity is cancelled by the SA as indicated at step 330. Alternatively, the SA may contact the buyer for negotiation. Should the opportunity be cancelled, the SA is able to flag the Opportunity Record and close the opportunity. The SA must, however, supply a reason for cancelling. The SA may select a reason from a Reason Table stored in the system. In a preferred embodiment, the information from the Opportunity Record is then used by the RAM to create an entry in a Cancelled Opportunity Table. The Opportunity is removed from the Opportunity Table. The Work List Entry is also removed, as are all Bid Records.

If, however, the buyer accepts the proposal at step 320, then the buyer authorizes the purchase and supplies the SA with a Purchase Order (PO) number as indicated at step 340. The SA proceeds to award the contract to the winning bidder or supplier. It will be appreciated that identifying a winning bid (or the awarding of an opportunity) is distinct from the actual awarding of a contract. Specifically, a contract is not awarded until the buyer accepts a supply proposal and provides the SA with a Purchase Order (PO) number.

At step 350, the SA inputs the PO number received from the buyer into the RAM on central host server 10 as well as the dollar amount of the order. The RAM then moves all of the information from the Opportunity Record into a new Order Record automatically deleting the Opportunity Record. Next, as indicated at step 360, the RAM produces the necessary ‘order’ documents (i.e. the purchase order, commercial invoice etc.) and identifies the shipping method. Subsequently, as indicated at step 370, the SA reviews the order documents before they are sent to the winning supplier. These order documents preferably take the form of PDF files stored in a Document Table within the RAM. In a preferred implementation, the RAM system further provides a summary screen that identifies what documents have been generated and that shows the Supplier ID, Supplier Name and the Supplier Email address. Preferably, the RAM is adapted to allow the SA to request that the order documents be sent to the winning supplier via email.

It will be appreciated that existing procurement management systems do not address challenges associated with the estimation of shipping costs and the provision of a waybill number for tracking purposes. Shipping costs are based on several factors which will vary from shipment to shipment even when it comes to the exact same part being shipped. The factors which influence shipping cost include weight and dimension, location of supplier in relation to the buyer, time of day relating to cut-off times for pick-up and level of service requested. The variability of these factors can lead to significant loss of revenue due to poor estimating practices, inadequate reconciliation procedures and supplier avarice. Even the best estimation model based on a significant volume of shipping activity spanning an acceptable period of time can only achieve a certain level of accuracy. The problem is further exacerbated given the tight timelines associated with Indirect Material MRO procurement. Research indicates that the inadequacy of existing systems to effectively determine shipping rates in conjunction with delivery requirements on a real-time basis may increase related shipping costs by as much as 30 to 40 per cent.

It will be also appreciated that the challenges associated with the timely provision of a tracking or waybill number has an operational/performance impact versus an immediate financial impact. Existing procurement systems rely entirely on the supplier to provide the waybill information on a timely basis. Delays in obtaining the waybill number decrease the likelihood of timely intervention in the event of a problem, impacting delivery performance.

The RAM system of the present invention automatically and electronically incorporates courier (shipping) companies in the procurement process thereby successfully addressing the challenges associated with shipping cost estimates and waybill number provision. This method of incorporating third party through a single event trigger is at the heart of the Metaprise model of the present invention. Referring now to FIG. 2E, at step 380, the selected supplier reviews the order documents (i.e. the Purchase Order and Commercial Invoice) which are received electronically. However, prior to receiving a Packing Slip, the supplier is instructed to enter the package's weight and dimensions in, for example, a set of ‘Tracking Information’ fields. Within seconds, and as indicted at step 390, courier algorithms within the RAM determine the best courier service for the shipment based on price, pick-up cut-off times per region, delivery destination as well as past delivery performance. It will be appreciated that the pricing and pick-up cut-off times for respective couriers are preferably stored in static tables within RAM. The information in these tables are provided and updated on a regular basis by the courier companies themselves.

Once the RAM courier algorithm determines the best shipping service for the current opportunity, a tracking Waybill Number is automatically generated within the RAM and simultaneously distributed to the supplier, the courier company's dispatch centre and a Tracking Agent (step 410). Next, at indicated at step 400, the package is prepared by the selected supplier for pick-up. Furthermore, the Packing Slip is automatically generated, sent to the supplier and subsequently printed at the supplier location for inclusion in the package being shipped. Upon receipt of the Waybill Number by the selected courier company, a simultaneous dispatch for pick-up from the supplier is executed as indicated at step 420.

Under the full service model of the RAM system of the present invention, the host or service provider acts as the financial arm in the procurement process. Specifically, the supplier may desire immediate payment by credit card before shipping of the sourced part or component to the buyer. If this is the case, the RAM host or service provider pays the supplier upfront and invoices the buyer separately. It will be appreciated, however, that the supplier and RAM host may have previously negotiated alternative payment terms as is well known in the art. Under the self-service model of the RAM wherein a buyer pays a licensing fee to access and use the RAM software, it is the responsibility of the buyer to settle payment terms with the supplier and other parties involved (i.e. the buyer assumes responsibility for all such activities related to invoicing).

Alleviated of the perpetual requirement of repeatedly trying to obtain a Waybill Number, the Tracking Agent may focus on monitoring the progress of the shipment from the supplier through to obtaining Proof of Delivery (POD) information as indicated at step 430. In so doing, the Tracking Agent confirms that the shipment arrived on time and in accordance with the buyer's specified delivery requirement.

Confirmation that a package has been delivered to the buyer/customer is essential to ensure that invoices are paid on a timely basis. Existing systems require the person responsible for tracking orders (i.e. the Tracking Agent) to log onto the courier's website until the Proof of Delivery (POD) information becomes available. Since the availability of the POD information is completely dependent on the scanning practices of the courier company's local driver, the Tracking Agent usually has to make repeated visits to the courier's website before obtaining the required POD information.

However, in the system of the present invention, the RAM automatically polls the courier company's website at timed intervals until the POD information becomes available. This automated polling function is illustrated at step 430. Once the buyer/customer receives the shipment (step 440), the courier website is updated accordingly with the POD. Once the POD information is available, the system automatically posts the POD information to the RAM as indicated at step 450, as well as simultaneously transmitting an email to both the Tracking Agent and the buyer/customer that the package has been delivered. It will be appreciated that this process frees up a significant amount of the Tracking Agent's time, giving the ability to oversee a significant volume of customer orders, as well as enabling the Tracking Agent to effectively manage delivery exceptions.

The final stage of the procurement process involves the conclusion of the transaction with the buyer/customer i.e. the reconciliation of invoices within the RAM, and the automatic withdrawal of the transaction fee from the buyer's financial institution.

Referring to FIG. 2F, upon receipt of the shipment, the buyer either accepts or returns the goods as indicated at step 460. If the shipment is accepted, transaction is completed and reconciled internally. The completion of the transaction triggers the automatic withdrawal (AWD) feature within the RAM as shown at step 470. Dependent of the agreed upon withdrawal period (1 to 15 days in a preferred embodiment), the applicable transaction fee is automatically withdrawn from the buyer's account. In a preferred embodiment, once a month the buyer will receive a monthly AWD statement, at which time they may review and/or dispute any charges. For example, if it is determined that a transaction fee should not have been charged, then an adjustment (credit) may be made on the buyer's next AWED statement.

It should be noted that the AWD feature described above applies to the ‘outsourcing’ model of the RAM only. In other words, it only applies to fees related to the processing of a transaction (i.e. transaction fees). Part costs and other related charges are invoiced separately and collected by traditional means.

If the buyer determines that the shipment received is unacceptable, then a Return Material Authorization (RMA) may be issued to the buyer and the return of the goods is coordinated by a RAM financial administrator. The RAM financial administrator may be the same person as the sourcing agent or tracking agent or may be a separate person distinct from these two people.

As shown in FIG. 2F, an order remains at status 80 until all related invoices are received and reconciled within the RAM. Invoices include the cost of the goods, shipping, duty etc. The reconciliation process involves the RAM financial administrator receiving invoices and entering the amount into the appropriate field within the specific order. Once all applicable invoices have been received and entered, the RAM verifies that there are no variances in the amounts charged. Concurrently, at step 490, the supplier, carrier and customs broker invoices are reconciled and the order is removed from the Work List (step 500). The order status changes to 85 and it is then removed from the Work List. If there is a discrepancy, the RAM will highlight the variance and the financial administrator proceeds to investigate. Any applicable adjustments made based on such investigation are noted. All orders which are delivered and accepted by the buyer/customer attain a status of 85.

In another scenario, the winning or selected supplier may want to change the delivery date after being awarded the contract. In such an instance, the SA may cancel the contract and shop elsewhere (this would count as a delivery problem against the supplier and effect the suppier's delivery points rating). However, the SA may also choose to negotiate with the customer and change e.g. the delivery date. For example, there are times when the exact delivery address is not known until the customer produces his purchase order.

It should be appreciated that from the time that the proposal is accepted by a buyer to the time that the buyer accepts the component, the RAM host automatically tracks the progress of the purchase from supplier to shipper, through customs and ultimately to the buyer. In addition, the RAM host serves as a bank, providing financing to the buyer i.e. paying the supplier once the part is accepted and approved by the buyer and then invoicing the buyer accordingly, all of which is performed automatically by the RAM system, as the completion of activities in the order cycle are confirmed.

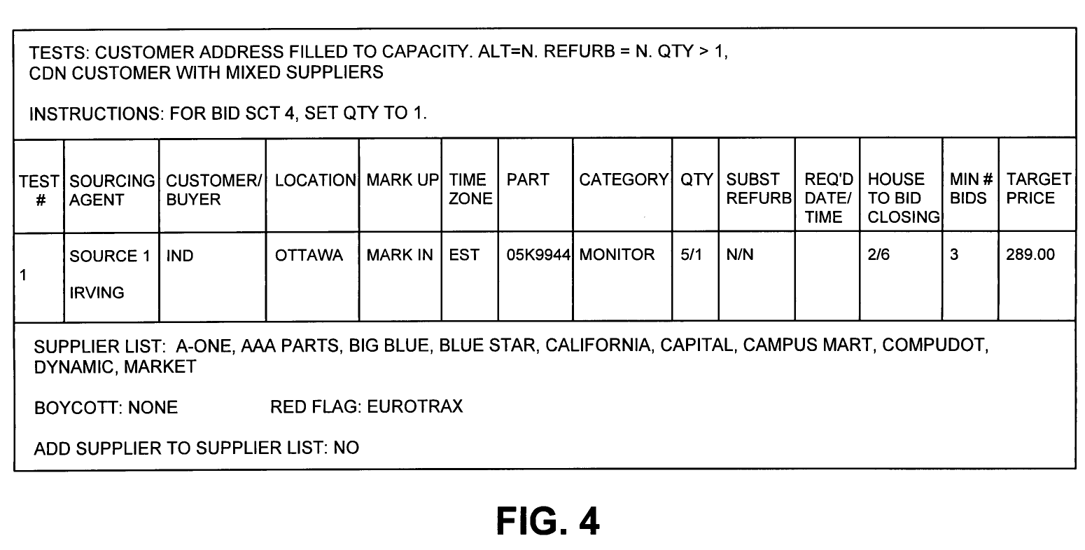

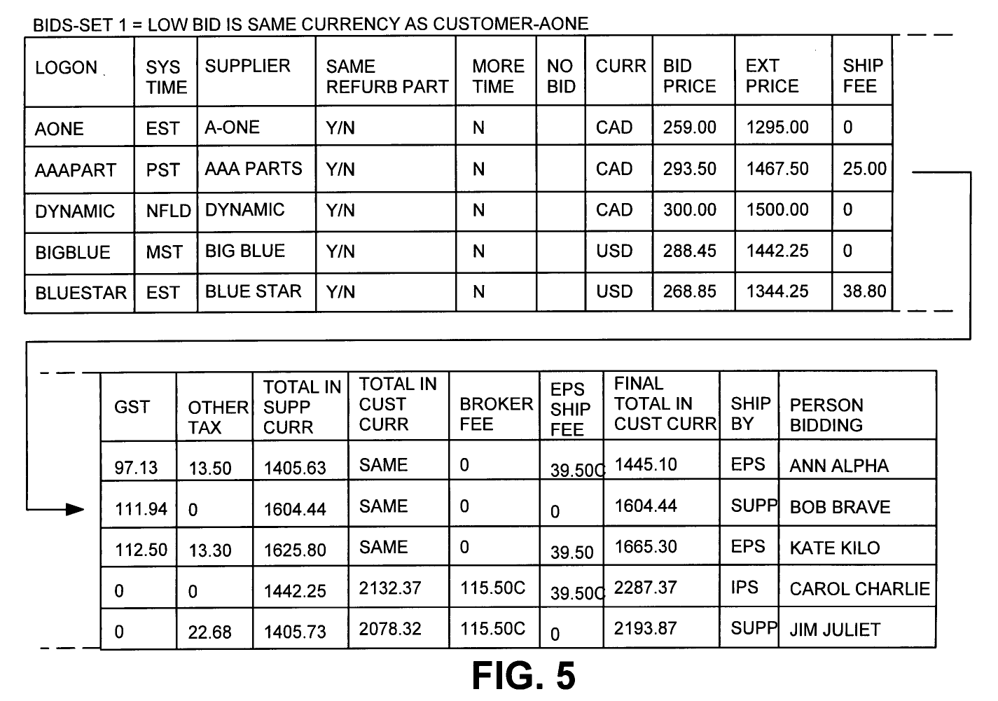

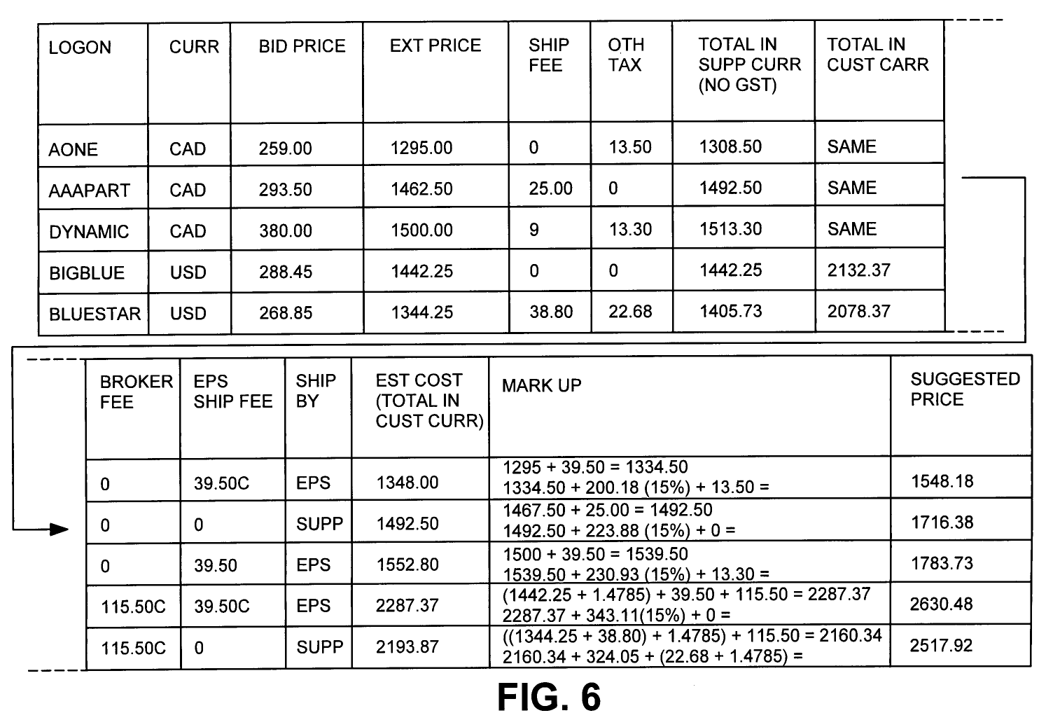

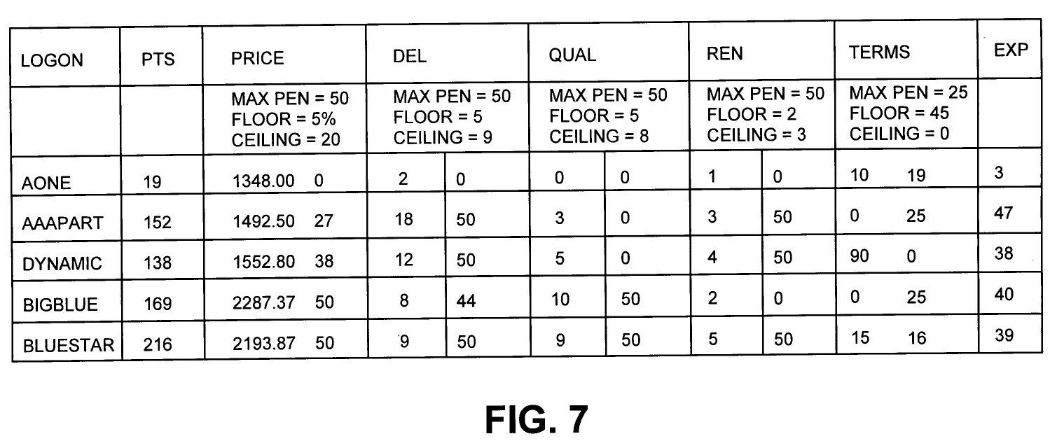

FIGS. 4 to 8 provide output tables created in RAM for a sample transaction. For example, FIG. 4 depicts a completed bid evaluation form from a buyer showing, among other things, the buyer identity, a list of eligible suppliers, a target price, the quantity required, and an item description. FIG. 5 depicts a bid submission table containing entries from bidding suppliers. The information includes the supplier, the bid price, taxes, brokerage fees and shipping fees. FIG. 6 depicts a Bid Review table containing, most significantly, the RAM host transaction fee (mark up) assuming the ‘outsourcing’ RAM model. FIG. 7 depicts a sample penalty points table containing penalty points assessed against each of the key purchasing criteria (price, delivery, quality, reneges and terms offered) for participating suppliers. In FIG. 7, the first column under each purchasing category is a rating which reflects past performance under that category (historical) while the second column under each category reflects penalty points assessed under that category for the current opportunity. The first column ‘Pts’ reflects total penalty points assessed (i.e. the sum of penalty points assessed under each category) for each supplier.

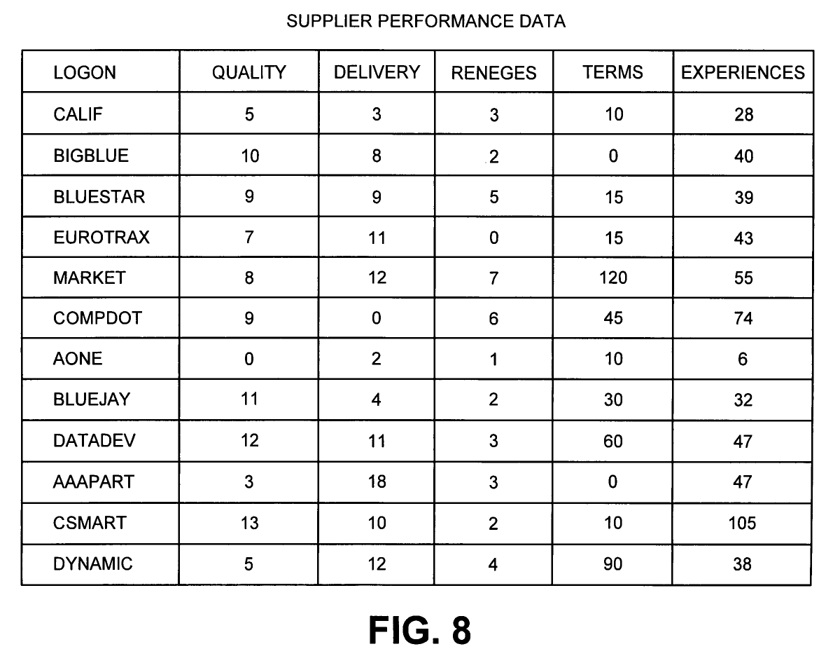

As highlighted in FIG. 8, in addition to price, other criteria such as delivery, time, quality of part, payment terms offered, etc. are evaluated in determining the best possible supplier. As shown by the ‘Pts’ column in the sample results of FIG. 7, the lowest price bidder (‘aone’) also accumulated the least amount of penalty points and, so, would qualify as the preferred supplier. However, it will be appreciated that the lowest price will not always qualify as the winning bid if the penalty points totals suggest otherwise or if history shows that the supplier is unreliable. The winning bid is determined by the supplier with the lowest total penalty points.

There are a number of administrative activities which occur throughout the RAM procurement process. For example, a Supplier Performance Table (SPT) is updated whenever an opportunity becomes an actual order; that is, when a buyer/customer Purchase Order Number is assigned. The Supplier's Performance Table record or entry is also updated any time an order is cancelled after POD and the reason for cancellation is supplier related. Other situations which may result in an update of a particular SPT entry include the following : (a) Dead on Arrival (DOA)—Supplier's problem; (b) Wrong Part Shipped (WPS)—Supplier's problem; (c) Shipment Late—Supplier's problem; (d) Supplier Renege; or (e) Supplier erroneous entry of shipping weight and dimensions. The SPT entry is also updated if a particular supplier has been contracted but does not ship (order has to be cancelled prior to shipping). It should be noted that the supplier will not be penalized if a late shipment is the result of shipper error.

If the Supplier Performance Table entry does not exist, the system will create one. Preferably, for each SPT entry, there exists a string (or any flexible format such as a table) of an arbitrary number, N, of characters called the Supplier Order Status. This keeps track of a particular supplier's most recent N orders. In a preferred embodiment, each character represents a transaction and can arbitrarily take on any one of the following potential values: (a) Blank—no order (has less than N experiences); (b) A—all is ok; (c) Q—quality problem, DOA or WPS; (d) D—delivery problem; and (e) R—supplier renege. As new orders (transactions) accumulate, the old information drops off the map. When an opportunity becomes an order, the system retrieves the SPT entry for the winning supplier and an ‘A’ is prepended to the string. It will appreciated that the number of transactions, N, accumulated or included within the Supplier Order Status string is arbitrary in that it may be established by the host. However, the number in the string must accomplish two things: (a) include a sufficient number of transactions to effectively measure supplier performance; and at the same time (b) not be too onerous whereby it takes the supplier and unreasonable amount of time to overcome a past error.

When a supplier error causes an order to be cancelled, the SA cancels the order and provides a reason. If the reason is supplier related the RAM system will also update the supplier's SPT entry by finding the first occurrence of an ‘A’ in the Supplier Order Status string and changing it to one of ‘Q’, ‘D’, or ‘R’. Any time the system updates the string, the system will also update the counts that are stored in the SPT. Although there is an unlimited capacity for storing N orders (e.g. N=250 as a starting point), a System Table field defines how many of those orders are to be considered when updating the counts.

A System Table field, evaluationNumberOfTransactions, dictates the number of characters within the Supplier Order Status string to evaluate. For example, if this field has a value of 100, the first 100 characters in the string (i.e. the last 100 transactions for that particular supplier) are used to count the number of A's, Q's, D's, and R's and update the counter fields in the respective supplier's SPT entry as follows:
(a) Number of Quality Problems=number of Q's;
(b) Number of Delivery problems=number of D's;
(c) Number of Reneges=number of R's; and
(d) Number of Transactions Considered=number of A+D+Q+R;

It will be appreciated that there may be times when an opportunity is sourced but the SA can only find a supplier who can fulfil the order in a week or two. This is referred to as a long estimated time of arrival (ETA) situation. In such instances, the buyer/customer is informed and may choose to proceed with the deal but ask that the SA continue to try and find a better (quicker) source. In this case, the SA awards the contract, but stipulates that the contract may be cancelled prior to shipping (if, for example, a quicker source is found). The SA further requests the system to generate a long ETA opportunity which is a new opportunity, identical to the long ETA order. The SA proceeds with that opportunity trying to find a quicker source. If a better or quicker source is found, the SA cancels the first order, obtains a new PO number from the buyer/customer and proceeds with the transaction using the new supplier. However, if the original order ships prior to finding a better (quicker) source, the SA cancels the second (long ETA) opportunity. Preferably, there is a field in both the Opportunity Table and the Order Table that allows the RAM system to link the 2 opportunities together. The system populates these fields appropriately when the long ETA opportunity is generated. For example, the field may be: Long ETA Opportunity ID.

In the system of the present invention, each registered supplier is able to select and review a list of opportunities that it has won. The supplier is able to select by date range (the default of which will be the current date). This provides a means of retrieving order documents (in PDF format) as well as a means of Inputting Way Bill Information.

In terms of Order cancellations, should an Order be cancelled, the SA can flag the Order Record as cancelled. The SA will supply a reason for cancelling. The cancelled order will remain on the Order Table. If the Order is cancelled and the Supplier is at fault, the system will update the Supplier Performance Table (SPT) entry for that particular supplier.

In other situations, it may happen that a supplier who has been awarded a contract may be unable to fulfil the contract. In such an instance, the SA is able to award the contract to one of the other bidders but may be forced to abide by the original price quoted to the buyer/customer. In addition, the SA may be forced to renegotiate delivery date requirements in order to award a new contract or may even have to re-solicit for the opportunity. The supplier that reneged on the opportunity will have a renege problem scored against their record. The SA will have to create a new Opportunity and potentially sole source depending on the required delivery date for the sourcing requirement i.e. enter a bid for the original runner up and award the contract for the new opportunity.

An order that gets cancelled because of a supplier-related quality problem e.g. Dead on Arrival (DOA) or Wrong Part Shipped (WPS), will result in a quality problem being registered against that particular supplier in the Supplier Performance Table. Cancelled reasons that begin with ‘sup’ count against the supplier: suprenege counts as an ‘R’; supdoa counts as a Q, supwps counts as a Q. Preferably, there are fields in the Order Table that allow the linking of cancelled orders to their replacement order should the need to trace the history arise. The fields are called: Replaced by Opportunity ID [forward pointer] and Replaces Opportunity ID [backward pointer].

It will be appreciated that the SA is in control of bid (auction) closing. As mentioned previously, there will always be a target date and time associated with the opportunity when the SA broadcasts the opportunity to registered suppliers. However, the bid will not physically close until the SA executes the “Bid Close” activity found on the Opportunity Detail screen. This allows the SA to extend the auction closing should more bids be required.

In relation to the Opportunity Status, for an Opportunity or an Order to change status, an action must have been taken by a Sourcing Agent or Manager or Support person. In other words, no status changes occur because of a time frame. Whenever the status changes for an Opportunity or an Order, the status will likewise be updated on the corresponding Work List Table entry.

A reverse auction host is able to select a particular Opportunity and from the detail screen select the “View Document” activity. The system presents all documents for this Opportunity that are stored in the Document Table that are available to this user role as defined in the Document Type Table. The user is able to select any of the documents and the system will extract the PDF file from the table and present it to the user. The user may view the document using the Adobe™ Acrobat Reader (or any PDF viewer) which will also provide a means for printing the document.

The RAM system of the present invention is further adapted to feed financial information to external financial packages. An external ASCII file in XML format is created that contains all relevant data. Triggering events are when goods are shipped to a customer location and when a shipped Order gets cancelled. The information that RAM extracts allows the host financial system to invoice the buyer/customer and, when necessary, give the customer a credit note.

The system of the present invention has additional functionality as follows:
(a) Reconcile Shipper Invoice: The system allows data entry of the following fields in the Order Table: Shipper Invoice Number, Shipper Invoice Date (date of reconciliation) and Shipper Invoice Amount. The person responsible for data entry can verify that the host has not been billed twice and that the host is responsible for the shipping on this Opportunity. Any discrepancies result in manual exception processing;
(b) Reconcile Supplier Invoice: The system allows the data entry of the following fields in the Order Table: Supplier Invoice Number, Supplier Invoice Date (date of reconciliation) and Supplier Invoice Amount. The person responsible for data entry can verify that the host has not been billed twice and that the amount does not exceed the contracted amount on a particular opportunity. Any discrepancies result in manual exception processing;
(c) Reconcile Customs Broker Invoice: The system allows the data entry of the following fields in the Order Table: Broker Id, Brokerage Invoice Date (date of reconciliation), Brokerage Invoice Amount. The person responsible for data entry can verify that the host has not been billed twice and that the amount is in accordance with the host arrangement with the broker. Any discrepancies result in manual exception processing;
(d) Input Way Bill Information: This function is only available to internal users as well as the supplier that has been awarded the opportunity. The system allows the user to input the WayBill which is recorded in the Order Table. The system also updates the dateWayBillEntered field. In a preferred implementation, this process is automated via a shipper algorithm (FIG. 2E, step 380 and 390);
(e) View Status Change Log: Once the user has identified an opportunity and is presented with the detail screen, this function is available from an activity list. When this is requested, the user is shown all of the Status Change Log entries that have this opportunity identifier.
(f) Alter Action and Escalation Targets Dates and Times: The action and escalation targets assist the SA in keeping on top of the procurement cycle. Once these times are reached for a specific Opportunity, the screen highlighting for that opportunity on the List of Work screen changes to draw attention to it. For example, attention may be drawn by three colour codes : green, amber and red where red, for example, indicates that immediate action is required. Every time that an internal user performs a function on an Opportunity that results in a status change, the system will present the user with a confirmation screen that will also show the system generated Action and Escalation targets for this new status. The system uses the Status Table to determine the default time to add to the current time in order to come up with the target. The user will be able to override the system generated targets with any date or time that is in the future. The system generated times may be totally inappropriate as they may occur on a weekend or in the middle of the night. The user will be able to assign a more appropriate time setting for these alarms. These alarms are only meant to assist the user as a memory aide;
(g) Recording a Late Delivery: The reverse auction host or service provider proactively tracks and monitors each shipment. If a shipment arrives late it is incumbent on the reverse auction host to investigate to determine why the shipment was late and record the event in the Order Table. The fields which are affected are onTime which is set to ‘N’ and late Reason which is set to a value from the Reason Table. If the shipment is late due to the supplier (i.e. lateReason=“suplate”) the system will also update the Supplier Performance Table and score a ‘D’ against the supplier.
(g) Reasons: Some activities, such as selecting a particular bid, cancelling an opportunity or an order, or a late delivery, require an explanation code (Reason ID) of why the event or action occurred. The reasons for such actions (i.e. explanation codes) are stored in a Reason Table. The first three characters of the Reason ID identify the party/event responsible for the action, which may be one of: corn (the company is responsible), cus (the customer is responsible), shp (the shipper is responsible), sup (the supplier is responsible) or bid (supplier bid status for the opportunity). The “shp” and “sup” prefixes are be used when determining the performance ratings.
(h) Document Production: Throughout the life cycle of an opportunity, certain documents must be generated. These documents include the following: PR—Proposal Document from SA to Customer; PO—Purchase Order from SA to supplier; AB—Air Bill from SA to supplier; CI—Commercial Invoice from SA to supplier; PS—Packing Slip from SA to supplier; SH—Order (shipping) papers from SA to supplier. Preferably, the system of the present invention generates these documents in PDF format. In a preferred implementation, the template for defining what the document looks like is an ASCII file with an inventor proprietary file extension of “.pdt”. The data required to properly prepare the document will be extracted from an SQL database into XML format. An executable called ‘mkPDF’ then combines the inventor proprietary PDT template with the XML data to produce a PDF file. The PDF file is stored in the SQL database in the Document Table. The PDFs can be viewed, emailed and printed. Rules about who can view a document are stored in a Document Type Table. This reference table also contains information used by the mkPDF program which describes the components necessary to produce the document. The reference table also has information that will help to establish when the document can be removed from the system.

The veracity of the bid system in the RAM of the present invention is constantly checked against the general market through mirrored sourcing. Mirrored sourcing enables the buyer to extend the bid process to sellers who may be registered, but have not had the opportunity to submit a bid, as well as to non-registered sellers who may not be aware of RAM or the opportunities available. Through this exercise, the floor and ceiling market price of a particular component or part may be established. This can, in turn, be used to effectively measure the bid pricing obtained through RAM to determine its position within the floor to ceiling range. Advantageously, the mirrored sourcing procedure is also a vehicle to drive new suppliers to register with the RAM service provider or host. For example, it has been shown that if a floor to ceiling price range analysis is conducted with the RAM system operating standalone without the benefit of mirrored sourcing, the bids received through RAM will be either the lowest or within 10% of the general markets lowest price or floor a certain nominal percentage (e.g. 15%) of the time. However, with mirrored sourcing complimenting the operation of the RAM over an appropriate length of time, bids received in RAM have proven to be the lowest, or within 10% of the general markets lowest price or floor a much greater percentage (e.g. 87%) of the time. The clear advantage of this check is that the integrity of the system can be maintained, ensuring that the best price is being offered to buyers.

In addition to fulfilling actual sourcing requirements, the (RAM) system of the present invention may also be used to provide business intelligence services to interested customers. Specifically, the RAM may be used to assist in the establishment of the open market ‘low’ and ‘high’ prices for components of interest which, in turn, may be used to generate a Price Range Analysis Report. The Price Range Analysis report is designed to establish the floor (low) to ceiling (high) price for IT related components and/or spare parts within a specified period of time taking into consideration the key primary procurement elements of a value-based transaction which include pricing, delivery performance capabilities and historic quality performance. Second tier procurement elements include terms offered and past reneges.

As in the case of the reverse auction bid solicitation methodology described before in relation to sourcing a particular part, through a complex series of advanced algorithms, the intelligent web-based procurement platform of the RAM may obtain the required pricing data on a real-time basis through a time sensitive bid solicitation process i.e. within a pre-defined time frame, respondents (suppliers) submit pricing for a component based on availability. When the auction is closed, the RAM matches the current value of pricing with the historical values of past delivery performance and quality for each participating supplier. Simultaneously, an algorithm based upon buyer-specified key procurement criteria (i.e. the bid evaluation parameters discussed previously) is executed enabling the RAM to list suppliers adhering to the principles of a value-based transaction.

In tandem with the above, the RAM host or sourcing agent may confirm the veracity of the bids received with the general ‘open’ market by executing the mirrored sourcing procedure. As discussed previously, this procedure is designed to guarantee the veracity of the bids received within the RAM by seeking alternative suppliers through more traditional sourcing methods. The results of the bidding process via the RAM combined with those achieved through the mirrored sourcing process ensure that the data used to establish the floor and ceiling prices associated with the Price Range Analysis Report are a true reflection of the general market as a whole. Again, the mirrored sourcing procedure is an integral part of the cross verification process which ensures that the RAM does not operate in a vacuum.

In a preferred implementation, the Price Range Analysis Report is available in two reporting formats. A first reporting format may be based upon “historic or target pricing’ wherein the historic or target pricing of a component is compared to the general market's low (floor) and high (ceiling) within a predefined time frame taking into account the principles of a value-based transaction. A second reporting format may focus on the pricing provided by suppliers from within a particular region. For example, pricing from Canadian-based suppliers may be compared to the North American market as a whole. As with the first reporting format, pricing information is gathered within a predefined time frame adhering to the principles of a value-based transaction. It will be appreciated that other customized reporting formats may be desired by customers and supplied, accordingly, by the RAM host. Furthermore, such reports will preferably be provided in any format which permits ease of analysis and data manipulation, Microsoft Excel being one such format.

In summary, the RAM of the present invention pre-selects suppliers (based on supplier categories set-up upon supplier registration) who are invited to bid on a particular parts request, awards bids based on objective algorithms (not just price) encompassing all critical components of a value-based transaction, provides financial risk management and fulfillment reconciliation. Furthermore, RAM is the first system which links Buyer and Seller algorithms resulting in a win-win situation for Buyer and Seller. Traditional or existing web-based auctions are subjective in nature and operate in a somewhat hostile environment where one party is attempting to extract a better deal at the expense of another party. For example, in order to eliminate competition in such existing web-based auctions, suppliers do not usually like to disclose their asking price until the last possible moment. Throughout the specification, the term courier has been used to refer to the entity that delivers the sourced part from the supplier to the buyer. It will be appreciated that any entity, be it a shipper, courier or carrier may be used for this purpose.

It will be appreciated that various pricing models may be used with the RAM system of the present invention. In a first model for example, the sourcing agent (SA) may solicit the bid, do the analysis and charge a transaction fee on the sourced part or requirement. In a second model, the customer/buyer himself may solicit bids via RAM, do the analysis, while the reverse auction host or service provider charges a transaction fee and buys the sourced requirement. In a third pricing model, the customer may use the RAM (central host server 10), do all the work (analysis) and pay a transaction fee to the reverse auction host. Finally, in a fourth pricing model, the customer may purchase a license from the reverse auction host to use the software and, therefore, pays for the license and annual maintenance fees or perhaps pays a transaction fee on a per transaction basis.

The invention as described focuses on the first two pricing models. In these models, the RAM software is running on a central host server. All of the data within the application is the property of the reverse auction host and multiple customers may be serviced from that application. In both of the first two pricing models, the reverse auction host (service provider) makes money by charging a transaction fee on each item sourced. In the first model, the reverse auction host arranges for the shipping of the item from the supplier to the customer site. The reverse auction host provides the supplier with the necessary order (shipping) documents such that the customer does not know who supplied the item (blind shipments).

With the second model, the customer plays a larger role in the buying process. The customer defines the “opportunity” and allows the system to send out bid solicitations to potential suppliers via email. The supplier information is reverse auction host confidential; therefore, supplier information (identification) is not given to the customer. Parts history and bid evaluation reports will cloak the supplier information when these reports are being delivered to a customer. During the bid request phase of the buy, any dialog from or to suppliers will go through a reverse auction host sourcing agent. The reverse auction host or service provider will pay the suppliers and shippers and will bill the customer appropriately with the inclusion of a transaction fee (either flat fee or percentage of purchase). It should be noted that the transaction fee percentage may be different based on the customer and pricing model.

The method of the present invention may be implemented in any conventional computer programming language for use with many computer architectures or operating systems. For example, preferred embodiments may be implemented in a procedural programming language (e.g. “C”) or an object oriented language (e.g. “C++”) for use with a Unix operating system. Further, the method of the present invention can be implemented as a computer program product for use with central host server 10. Such implementation may include a series of computer instructions fixed either on a tangible medium, such as a computer readable medium (e.g., a diskette, CD-ROM, ROM, or fixed disk) or transmittable to the central server 14, via a modem or other interface device, such as a communications adapter connected to wide area network 20 over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Furthermore, such instructions are stored in the central storage device which may be a semiconductor, magnetic, optical or other memory device, and may be transmitted using any communications technology, such as optical, infrared, microwave, or other transmission technologies. It is expected that such a computer program product may be distributed as a removable medium with accompanying printed or electronic documentation (e.g., shrink wrapped software), preloaded onto the central host server 10 (e.g., on system ROM or fixed disk), or distributed from a server (not shown) over wide area network 20. Of course, some embodiments of the invention may be implemented as a combination of both software (e.g., a computer program product) and hardware. Still other embodiments of the invention may be implemented as entirely hardware, or entirely software.

Although various exemplary embodiments of the invention have been disclosed, it should be apparent to those skilled in the art that various changes and modifications can be made which will achieve some of the advantages of the invention without departing from the true scope of the invention.

A person understanding this invention may now conceive of alternative structures and embodiments or variations of the above all of which are intended to fall within the scope of the invention as defined in the claims that follow.

We claim:

1. A real-time computer-implemented method for conducting a reverse auction for a maintenance, repair and operation (MRO) component comprising:
(a) creating an opportunity wherein said creating comprises generating a bid evaluation form for a buyer, said bid evaluation form comprising a component description and a plurality of buyer selectable bid evaluation parameters including a weight for each of said parameters;
(b) receiving and storing a completed bid evaluation form from said buyer;
(c) determining a list of potential suppliers for satisfying said opportunity;
(d) broadcasting said opportunity to said list of potential suppliers;
(e) receiving a bid from each of said potential suppliers;
(f) evaluating said received bids;
(g) determining a winning bid from said evaluated bids;
(h) creating a buyer proposal;
(i) awarding a contract to a selected one of said potential suppliers; and
(j) selecting a courier for delivering the component to the buyer
wherein a bid price is verified through mirrored sourcing, and wherein said mirrored sourcing comprises checking a bid price offered by said potential suppliers against a market price offered by selected non-participating suppliers.

2. The method of claim 1 wherein said determining a list of potential suppliers comprises disqualifying potential suppliers boycotted by said buyer.

3. The method of claim 2 wherein said determining a list of potential suppliers comprises verification of said list by a sourcing agent.

4. The method of claim 1 wherein said broadcasting comprises sending an e-mail to each of said potential suppliers.

5. The method of claim 1 wherein said broadcasting comprises a specified one of said potential suppliers logging into a central host server and reviewing a list of opportunities.

6. The method of claim 1 wherein said receiving a bid comprises a specified one of said potential suppliers linking to a central host server, entering a user identification and password and entering a bid.

7. The method of claim 1 wherein said receiving a bid further includes modification by a sourcing agent.

8. The method of claim 6 wherein said receiving a bid comprises determining if a brokerage fee is required and adding said brokerage fee to said bid.

9. The method of claim 6 wherein said receiving a bid comprises determining a supplier country and buyer country, converting from a supplier currency to a buyer currency and adding to a bid amount a brokerage fee.

10. The method of claim 1 wherein said evaluating a bid comprises reviewing a supplier performance table and determining penalty points reflecting historic problems associated with price, delivery, contract terms, quality, and reneging of a specified potential supplier.

11. The method of claim 1 wherein said evaluating a bid further includes modification by a sourcing agent.

12. The method of claim 11 wherein said modification comprises determining a transaction fee and adding said transaction fee to a bid price associated with a specified potential supplier.

13. The method of claim 1 wherein said creating a customer proposal comprises generating a PDF document of a winning bid and sending said winning bid to said buyer.

14. The method of claim 1 further comprising updating a supplier performance table associated with a winning supplier.

15. The method of claim 1 further comprising tracking said component associated with a winning bid from said selected one of said potential suppliers to said buyer.

16. The method of claim 1 further comprising providing financial management of said awarded contract wherein said financial management comprises providing payment to said selected one of said potential suppliers, providing credit to said buyer and invoicing said buyer.

17. The method of claim 1 further comprising generating a history report of all transactional activity relating to a specified buyer.

18. A system for conducting a real-time reverse auction for a maintenance, repair and operation (MRO) component comprising:
(a) at least one central host server; and
(b) a host terminal communicating with said central host server,
wherein said at least one central host server comprises a reverse auction module (RAM) and wherein said RAM comprises:
(a) a first creation sub-module for creating an opportunity wherein said creating comprises generating a bid evaluation form for a buyer at a remote buyer terminal, said bid evaluation form comprising a component description and a plurality of buyer selectable bid evaluation parameters including a weight for each of said parameters;
(b) a first receiving sub-module for receiving and storing a completed bid evaluation form from said buyer at said remote buyer terminal;
(c) a first determining sub-module for determining a list of potential suppliers for satisfying said opportunity;
(d) a broadcasting sub-module for broadcasting said opportunity to said list of potential suppliers at respective remote supplier terminals;
(e) a second receiving sub-module for receiving a bid from each of said potential suppliers;
(f) an evaluation sub-module for evaluating said received bids;
(g) a second determining module for determining a winning bid from said evaluated bids;
(h) a second creation sub-module for creating a buyer proposal; and
(i) an awarding sub-module for awarding a contract to a selected one of said potential suppliers,
wherein a bid price is verified through a mirror sourcing module, and wherein said mirror sourcing module checks a bid price offered by said potential suppliers against a market price offered by selected non-participating suppliers.

19. The system of claim 18 wherein said at least one central host server communicates with said remote buyer terminal and said remote supplier terminal via a network selected from the group comprising an intranet, a wide area network and the Internet.

20. The system of claim 18 wherein said broadcast module sends an e-mail to respective remote supplier terminals.

21. The system of claim 18 wherein a specified supplier logs into said broadcast module from an associated remote supplier terminal and reviews a list of opportunities.

22. The system of claim 18 wherein a specified one of said potential suppliers links to said RAM receiver module from an associated remote supplier terminal, enters a user identification and password, and enters a bid.

23. A computer-readable medium having stored thereon, computer executable instructions which, when executed by a central host server cause the server to:
(a) create an opportunity wherein said creating comprises generating a bid evaluation form for a buyer, said bid evaluation form comprising a component description and a plurality of buyer selectable bid evaluation parameters including a weight for each of said parameters;
(b) receive and store a completed bid evaluation form from said buyer;
(c) determine a list of potential suppliers for satisfying said opportunity;
(d) broadcast said opportunity to said list of potential suppliers;
(e) receive a bid from each of said potential suppliers;
(f) evaluate said received bids;
(g) determine a winning bid from said evaluated bids;
(h) create a buyer proposal; and
(i) award a contract to a selected one of said potential suppliers,
wherein a bid price is verified through mirror sourcing, and wherein said mirror sourcing comprises checking a bid price offered by said potential suppliers against a market price offered by selected non-participating suppliers.

24. In a system for conducting a real-time reverse auction for a maintenance, repair and operation (MRO) component, a memory for storing data for access by an application program being executed on a central host server, comprising a data structure stored in said memory, said data structure including information resident in a database used by said application program and including:
(a) a bid evaluation table containing bid evaluation parameters;
(b) a table containing a list of active suppliers;
(c) a table containing a list of opportunities; and
(d) a table containing supplier performance date,
wherein said application program is a reverse auction module (RAM), and wherein a bid price received in relation to a specified reverse auction is verified through mirror sourcing, and wherein said mirror sourcing comprises checking a bid price offered by said potential suppliers against a market price offered by selected non-participating suppliers.

25. A real-time computer-implemented method for generating a Price Range Analysis Report for a Maintenance Repair and Operations (MRO) component comprising:
(a) receiving a pricing request from a customer including a vendor part number for said MRO component, a complete description of said MRO component, a target price of said MRO component, a specified period of time in which said pricing request is to be gathered and, optionally, a region in which to conduct said pricing request;
(b) determining a list of potential suppliers to solicit for said pricing request;
(c) broadcasting said pricing request to said list of potential suppliers;
(d) receiving and storing a bid price from each of said potential suppliers who respond within said specified period of time in which said pricing request is to be gathered; and
(e) generating said Price Range Analysis Report, comprising a component description, a high bid price and a low bid price,
wherein said received bid prices are verified through mirror sourcing and wherein said mirror sourcing comprises checking said bid prices offered by said potential suppliers against market prices offered by selected non-participating suppliers.
